(19) United States
(12) Patent Application Publication
(10) Pub. No.: US 2026/0324875 A1
(43) Pub. Date: Oct. 22, 2026

(54) AIR MATTRESS SYSTEM

(71) Applicant: National Taiwan University of Science and Technology, Taipei (TW)

(72) Inventors: Chyi-Yeu Lin, Taipei (TW); . Bahrudin, Taipei (TW); Nathnael Abebaw Siyoum, Taipei (TW)

(73) Assignee: National Taiwan University of Science and Technology, Taipei (TW)

(21) Appl. No.: 19/373,750

(22) Filed: Oct. 30, 2025

(30) Foreign Application Priority Data
Apr. 17, 2025 (TW) 114114654

(51) Int. Cl. A47C 27/10; A47C 27/08

(52) U.S. Cl. CPC A47C 27/10; A47C 27/083

(57) ABSTRACT

An air mattress system includes a mattress and a controller. The mattress includes a mattress body, at least one air bag structure and at least one air pressure valve. The mattress body is configured to support a human body, the air bag structure is disposed on the mattress body, and the air pressure valve is connected to the air bag structure. The controller is coupled to the air pressure valve. The controller is configured to control the air pressure valve to perform an inflation operation or a deflating operation on the air bag structure. The air bag structure expands along an up-down direction of the mattress body in response to the inflation operation, so as to guide two legs of the human body on the mattress body to be lifted and open relatively as the at least one air bag structure expands.

### CROSS-REFERENCE TO RELATED APPLICATION

This application claims the priority benefit of Taiwan application serial no. 114114654, filed on Apr. 17, 2025. The entirety of the above-mentioned patent application is hereby incorporated by reference herein and made a part of this specification.

### BACKGROUND

### Technical Field

The disclosure relates to an air mattress, and particularly relates to an air mattress system.

### Related Art

The global aging trend is irreversible, with more elderly people becoming long-term bedridden patients before the end of life and requiring caregiver care. The most difficult caregiving motions include: putting on and removing diapers, putting on and taking off pants and clothes. These motions all require moving specific human body parts of the patient. If these motions are performed for a long time, it will cause occupational injuries and physical burden to caregivers.

### SUMMARY

Embodiments of the disclosure provide an air mattress system that may assist caregiving motions.

The air mattress system of the disclosure includes a mattress and a controller. The mattress includes a mattress body, at least one air bag structure, and at least one air pressure valve. The mattress body is configured to carry a human body, the air bag structure is disposed on the mattress body, and the air pressure valve is connected to the air bag structure. The controller is coupled to the air pressure valve. The controller is configured to control the air pressure valve to perform an inflation operation or a deflation operation on the air bag structure. The air bag structure expands along an up-down direction of the mattress body in response to the inflation operation, so as to guide two legs of the human body on the mattress body to be lifted and open relatively as the at least one air bag structure expands.

In an embodiment of the disclosure, in a head-to-tail direction of the mattress body, the air bag structure is closer to a tail end of the mattress body than to a center of the mattress body.

In an embodiment of the disclosure, the air bag structure has a central part and at least one side part, and a size increase amount of the side part along a size increase direction in response to the inflation operation is different from a size increase amount of the central part along the size increase direction in response to the inflation operation.

In an embodiment of the disclosure, an expandable degree of the air bag structure at the central part is greater than tan expandable degree of the air bag structure at the side part.

In an embodiment of the disclosure, the size increase direction is parallel to the up-down direction of the mattress body, the air bag structure has at least one guide surface in response to the inflation operation, and the guide surface is adapted to guide the two legs of the human body to open relatively or close relatively.

In an embodiment of the disclosure, the guide surface continuously extends between the central part and the side part.

In an embodiment of the disclosure, the size increase amount of the side part along the size increase direction in response to the inflation operation is smaller than the size increase amount of the central part along the size increase direction in response to the inflation operation, such that the air bag structure has the guide surface extending obliquely downward from the central part to the side part.

In an embodiment of the disclosure, the air bag structure has at least two air bag structures, one of the at least two air bag structures is closer to a center of the mattress body than another one of the at least two air bag structures in a left-right direction of the mattress body, the guide surface of the one of the at least two air bag structures is adapted to guide the two legs of the human body on the mattress body to open relatively, and the guide surface of the another one of the at least two air bag structures is adapted to guide the two legs of the human body on the mattress body to close relatively.

In an embodiment of the disclosure, in a head-to-tail direction of the mattress body, the one of the at least two air bag structures is closer to a tail end of the mattress body than the another one of the at least two air bag structures.

In an embodiment of the disclosure, the size increase amount of the side part along the size increase direction in response to the inflation operation is greater than the size increase amount of the central part along the size increase direction in response to the inflation operation, such that the air bag structure has the at least one guide surface extending obliquely downward from the side part to the central part.

In an embodiment of the disclosure, the guide surface is a curved surface or an inclined surface.

In an embodiment of the disclosure, the guide surface has two guide surfaces, the air bag structure has two blocks, the two blocks respectively correspond to the two guide surfaces, and when observed along the up-down direction of the mattress body, each of the blocks extends along a direction inclined to a left-right direction of the mattress body to make the air bag structure V-shaped.

In an embodiment of the disclosure, the air bag structure has at least two air bag parts, the at least two air bag parts are adjacent to each other but not interconnected, the inflation operation inflates one of the at least two air bag parts such that the size increase amount of the side part along the size increase direction in response to the inflation operation is smaller than the size increase amount of the central part along the size increase direction in response to the inflation operation, or inflates another one of the at least two air bag parts such that the size increase amount of the side part along the size increase direction in response to the inflation operation is greater than the size increase amount of the central part along the size increase direction in response to the inflation operation.

In an embodiment of the disclosure, the one of the two air bag parts has a plurality of first sub-air bag parts. The first sub-air bag parts are sequentially stacked along the up-down direction of the mattress body, and an expandable degree of one end of each of the first sub-air bag parts located at the central part is greater than an expandable degree of one end of each of the first sub-air bag parts located at the side part. The another one of the at least two air bag parts has a plurality of second sub-air bag parts. The second sub-air bag parts are sequentially stacked along the up-down direction of the mattress body, and an expandable degree of one end of each of the second sub-air bag parts located at the central part is smaller than an expandable degree of one end of each of the second sub-air bag parts located at the side part.

In an embodiment of the disclosure, the size increase direction is parallel to a left-right direction of the mattress body, and the size increase amount of the side parts along the size increase direction in response to the inflation operation is greater than the size increase amount of the central part along the size increase direction in response to the inflation operation, such that the side part is adapted to push a leg of the human body on the mattress body along the size increase direction in response to the inflation operation so as to the guide two legs of the human body to open relatively.

In an embodiment of the disclosure, the air bag structure has a plurality of branch parts. The branch parts are sequentially stacked along the up-down direction of the mattress body, and the branch parts are connected to each other at the side part and separated from each other at the central part.

In an embodiment of the disclosure, an expandable degree of a bottom surface of the air bag structure is greater than an expandable degree of a top surface of the air bag structure.

In an embodiment of the disclosure, the air mattress system further includes at least one auxiliary air bag and at least another air pressure valve. The auxiliary air bag is disposed on the mattress body, the at least another air pressure valve is connected to the auxiliary air bag, the controller is coupled to the at least another air pressure valve, and the controller is configured to control the at least another air pressure valve to deflate the auxiliary air bag, such that the auxiliary air bag contracts along the up-down direction of the mattress body to form an accommodation space between the auxiliary air bag and the human body on the mattress body.

In an embodiment of the disclosure, in a head-to-tail direction of the mattress body, the air bag structure is closer to a tail end of the mattress body than the auxiliary air bag.

Based on the above, in the air mattress system of the embodiment of the disclosure, the air bag structure expands along the up-down direction after inflation operation so as to guide two legs of the human body on the mattress body to be lifted and open relatively or close relatively. Accordingly, it may assist caregiving motions to avoid occupational injuries to caregivers and reduce physical burden on patients.

### BRIEF DESCRIPTION OF THE DRAWINGS

FIG. 1 is a schematic view of an air mattress system according to an embodiment of the disclosure.

FIG. 2A is a three-dimensional view of the mattress of FIG. 1.

FIG. 2B illustrates the mattress body of FIG. 2A carrying a human body.

FIG. 3A and FIG. 3B respectively illustrate partial air bag structures of FIG. 2A and FIG. 2B being inflated.

FIG. 4A and FIG. 4B respectively illustrate partial air bag structures of FIG. 2A and FIG. 2B being deflated.

FIG. 5A is a three-dimensional view of a mattress according to another embodiment of the disclosure.

FIG. 5B illustrates the mattress body of FIG. 5A carrying a human body.

FIG. 6A and FIG. 6B respectively illustrate the air bag structures of FIG. 5A and FIG. 5B being inflated.

FIG. 7A and FIG. 7B respectively illustrate the air bag structures of FIG. 5A and FIG. 5B being deflated.

FIG. 8 to FIG. 10 are respectively schematic views of the air bag structures of FIG. 5A, FIG. 6A, and FIG. 7A.

FIG. 11A is a three-dimensional view of a mattress according to another embodiment of the disclosure.

FIG. 11B illustrates the mattress body of FIG. 11A carrying a human body.

FIG. 12A and FIG. 12B respectively illustrate the air bag structures of FIG. 11A and FIG. 11B being inflated.

FIG. 13A and FIG. 13B respectively illustrate the air bag structures of FIG. 12A and FIG. 12B being further inflated.

FIG. 14A and FIG. 14B respectively illustrate the air bag structures of FIG. 13A and FIG. 13B being deformed.

FIG. 15A and FIG. 15B respectively illustrate the air bag structures of FIG. 14A and FIG. 14B being deformed.

FIG. 16 to FIG. 20 are respectively schematic views of the air bag structures of FIG. 11A, FIG. 12A, FIG. 13A, FIG. 14A, and FIG. 15A.

FIG. 21A is a three-dimensional view of a mattress according to another embodiment of the disclosure.

FIG. 21B illustrates the mattress body of FIG. 21A carrying a human body.

FIG. 22 illustrates the air bag structure of FIG. 21B being inflated.

FIG. 23A is a three-dimensional view of a mattress according to another embodiment of the disclosure.

FIG. 23B illustrates the mattress body of FIG. 23A carrying a human body.

FIG. 24 illustrates the air bag structure of FIG. 23B being inflated.

FIG. 25 is a front view of the mattress of FIG. 24.

FIG. 26 is a three-dimensional view of the local air bag structure of FIG. 23A.

FIG. 27 is a three-dimensional view of the local air bag structure of FIG. 24.

FIG. 28A is a three-dimensional view of a mattress according to another embodiment of the disclosure.

FIG. 28B illustrates the mattress body of FIG. 28A carrying a human body.

FIG. 29 illustrates the air bag structure of FIG. 28B being inflated.

FIG. 30 is a front view of the mattress of FIG. 29.

FIG. 31 is a three-dimensional view of the local air bag structure of FIG. 28A.

FIG. 32 is a three-dimensional view of the local air bag structure of FIG. 29.

### DESCRIPTION OF THE EMBODIMENTS

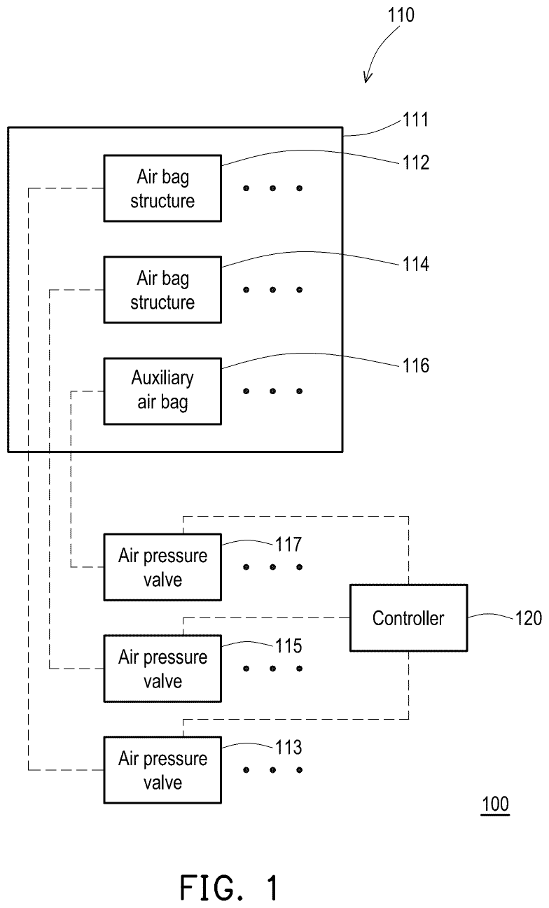

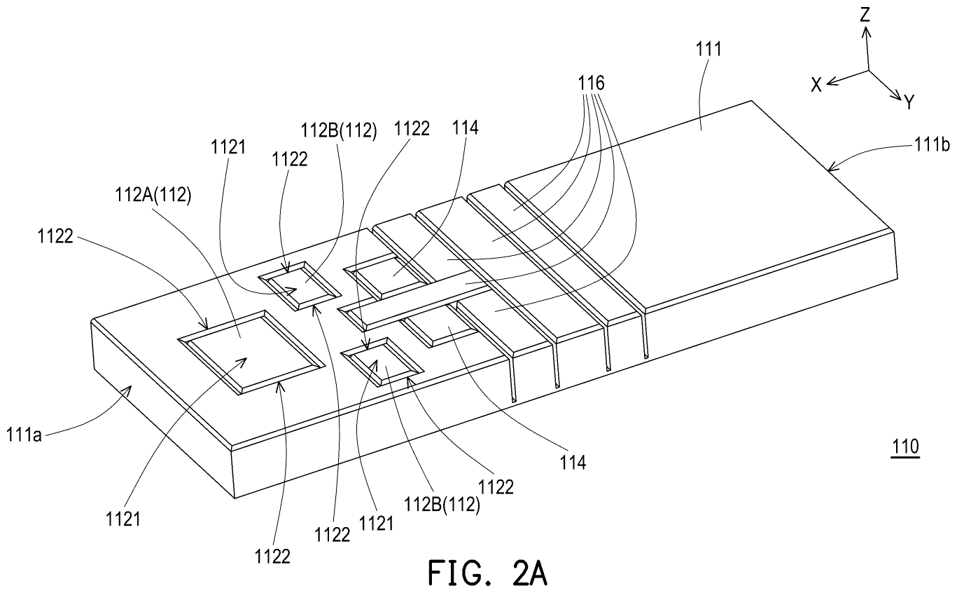

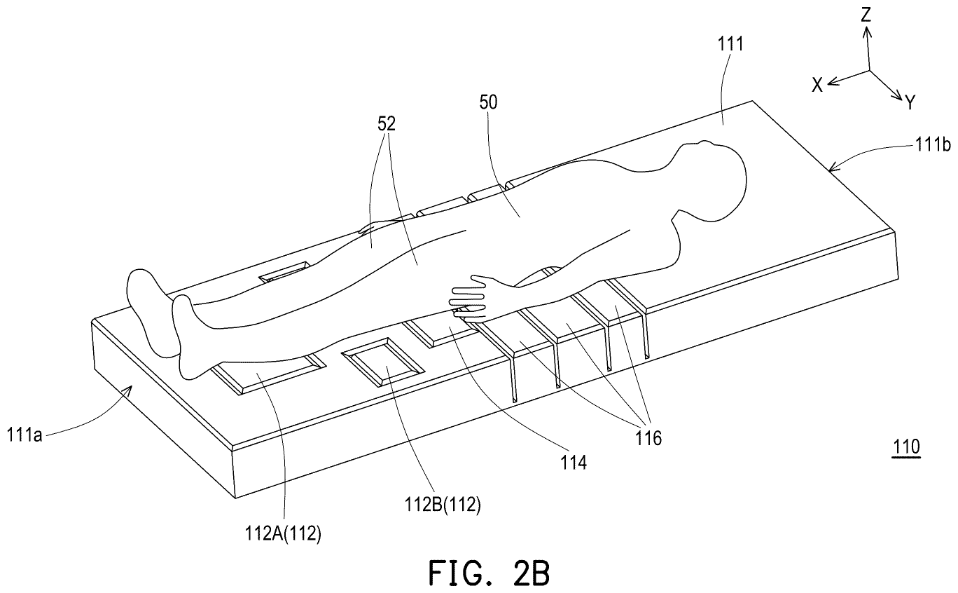

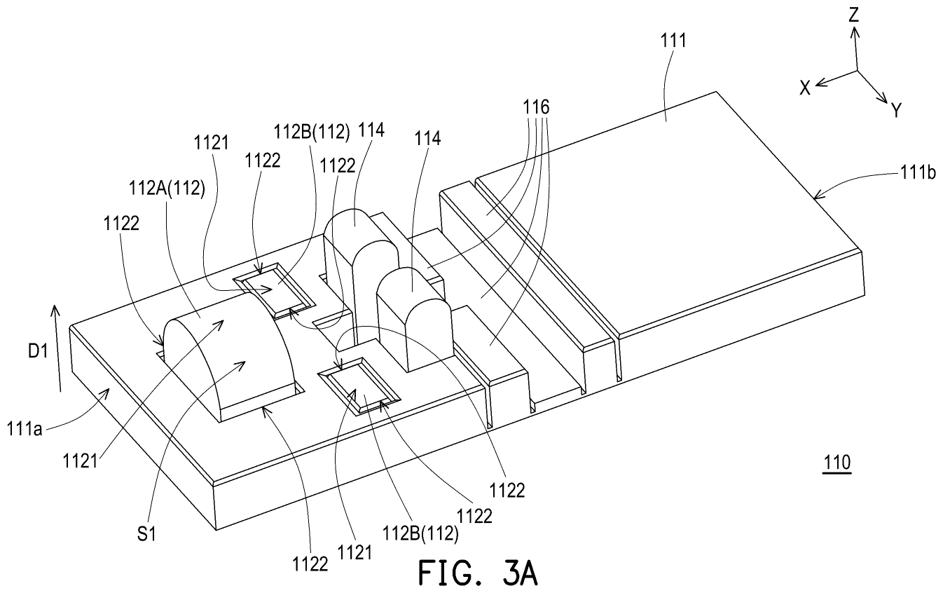

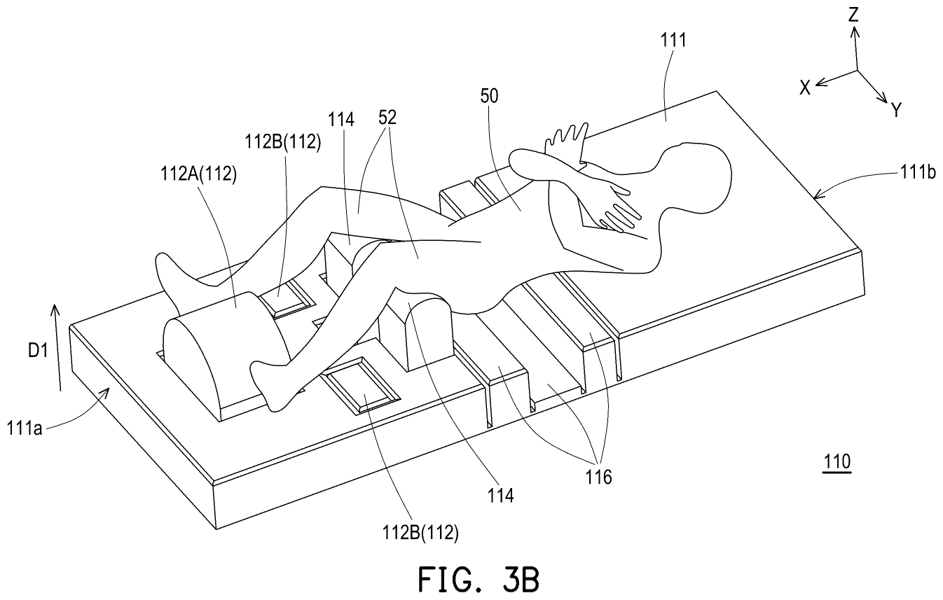

FIG. 1 is a schematic view of an air mattress system according to an embodiment of the disclosure. FIG. 2A is a three-dimensional view of the mattress of FIG. 1. FIG. 2B illustrates the mattress body of FIG. 2A carrying a human body. Referring to FIG. 1 to FIG. 2B, an air mattress system 100 of this embodiment includes a mattress 110 and a controller 120. The mattress 110 includes a mattress body 111, a plurality of air bag structures 112, a plurality of air pressure valves 113 and a plurality of air pressure valves 115. The mattress body 111 may be rectangular, square, or other shapes, and is configured to carry a human body 50 as shown in FIG. 3A and FIG. 3B. The air bag structure 112 includes an air bag structure 112A, two air bag structures 112B, and two air bag structures 114 as shown in FIG. 2.

The air bag structures 112A, 112B, and 114 are disposed on the mattress body 111. In a head-to-tail direction (axial direction X) of the mattress body 111, the air bag structures 112A, 112B, and 114 are closer to a tail end 111a of the mattress body 111 than a geometric center of the mattress body 111, and the air bag structure 112A is closer to the tail end 111a of the mattress body 111 than the air bag structures 112B. The air bag structure 112A is closer to the geometric center of the mattress body 111 than the air bag structures 112B in the left-right direction (axial direction Y) of the mattress body 111.

Each of the air bag structures 112A and 112B has a central part 1121 and two side parts 1122, with the two side parts 1122 respectively located on opposite sides of the central part 1121 in the left-right direction (axial direction Y) of the mattress body 111. The air pressure valves 113 are respectively connected to the air bag structures 112A and 112B, and the air pressure valves 115 are respectively connected to the air bag structures 114. The controller 120 is coupled to the air pressure valves 113 and is configured to control the air pressure valves 113 to perform an inflation operation or a deflation operation on the air bag structures 112A and 112B. The controller 120 may be a desktop computer, a laptop computer, a smartphone, a tablet computer, a workstation, a host computer, or other devices or processors (for example, Central Processing Unit (CPU), microcontroller, programmable controller, Application-Specific Integrated Circuit (ASIC), chip, or other similar components or combinations of the components).

FIG. 3A and FIG. 3B respectively illustrate partial air bag structures of FIG. 2A and FIG. 2B being inflated. In the initial state shown in FIG. 2A and FIG. 2B, the air bag structures 112A, 112B, and 114 are, for example, all flush with the surface of the mattress body 111. As shown in FIG. 3A, after the air pressure valve 113 inflates the air bag structure 112A, the air bag structure 112A expands along the up-down direction (axial direction Z) of the mattress body 111. The expandable degree of the air bag structure 112A at the central part 1121 is greater than the expandable degree of the air bag structure 112A at the side parts 1122. The central part 1121 in the uninflated state shown in FIG. 2A has, for example, more folds than the side parts 1122 and thus has a greater expandable degree. Therefore, as shown in FIG. 3A, the size increase amount of the side parts 1122 of the air bag structure 112A along a size increase direction D1 parallel to the up-down direction (axial direction Z) of the mattress body 111 in response to the inflation operation is smaller than the size increase amount of the central part 1121 of the air bag structure 112A along the size increase direction D1 in response to the inflation operation. At this time, the size of the side parts 1122 of the air bag structure 112A along the size increase direction D1 is smaller than the size of the central part 1121 of the air bag structure 112A along the size increase direction D1, such that the air bag structure 112A is adapted to guide two legs 52 of the human body 50 on the mattress body 111 to open relatively as the air bag structures 112A expand, as shown in FIG. 3B. In addition, after the air pressure valves 115 inflate the air bag structures 114, the air bag structures 114 expand along the up-down direction (axial direction Z) of the mattress body 111 as shown in FIG. 3A so as to guide the two legs 52 of the human body 50 on the mattress body 111 to be lifted as the air bag structures 114 expand, as shown in FIG. 3B. Accordingly, through the joint action of the air bag structures 112A and 114, the two legs 52 of the human body 50 are lifted and open relatively, such that it is easier for the caregiver to perform caregiving motions on the human body 50 such as putting on and removing diapers and cleaning body parts contaminated by urine and feces.

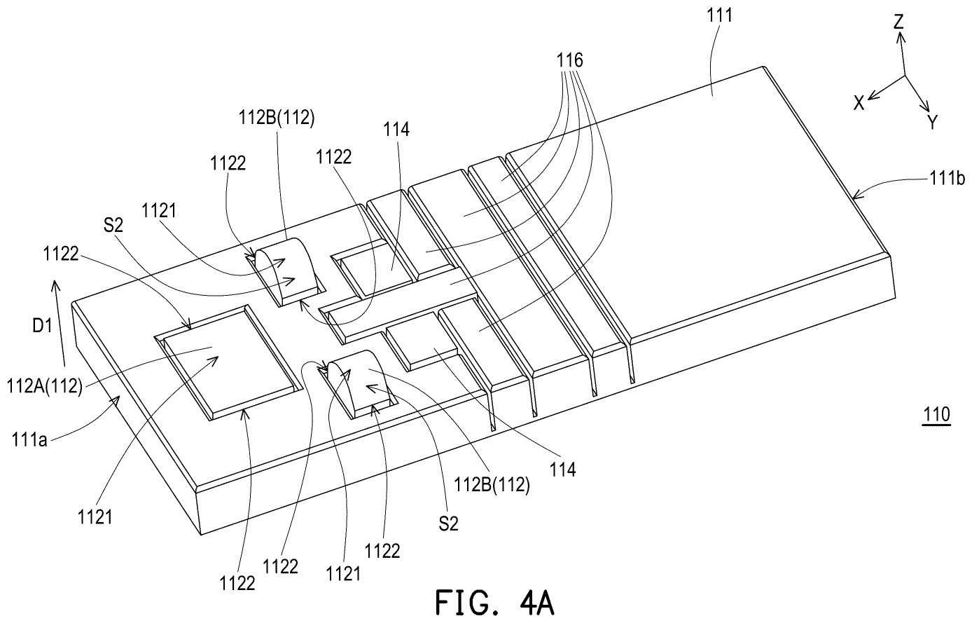

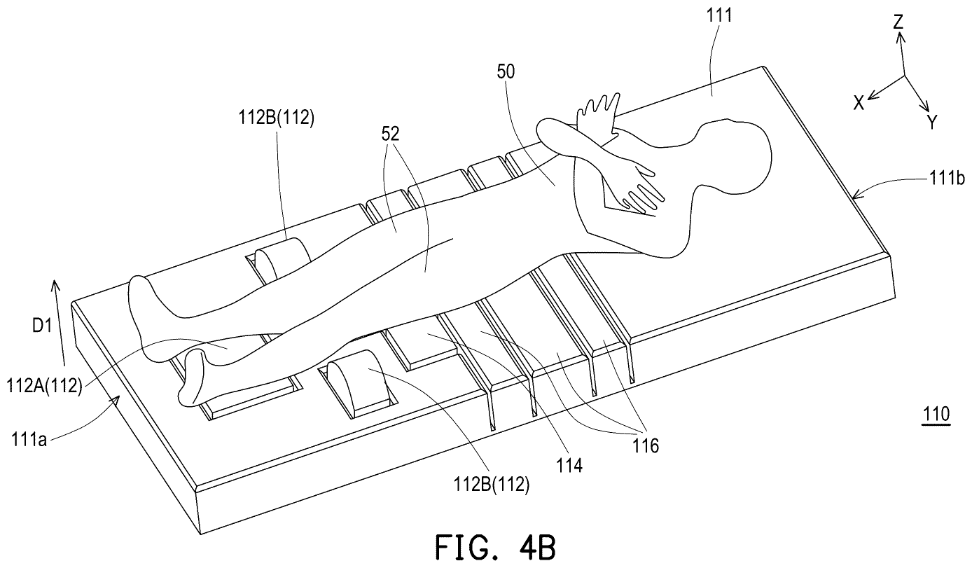

FIG. 4A and FIG. 4B respectively illustrate partial air bag structures of FIG. 2A and FIG. 2B being deflated. Next, as shown in FIG. 4A, after the air pressure valves 113 and 115 deflate the air bag structures 112A and 114 and inflate the air bag structure 112B, the air bag structures 112A and 114 return from the expanded state shown in FIG. 3A to the non-expanded state shown in FIG. 4A, and the air bag structures 112B expand. The expandable degree of the air bag structure 112B at the central part 1121 is greater than the expandable degree of the air bag structure 112B at the side parts 1122. The central part 1121 in the uninflated state shown in FIG. 2A has, for example, more folds than the side parts 1122 and thus has a greater expandable degree. Therefore, as shown in FIG. 4A, the size increase amount of the side parts 1122 of the air bag structure 112B along the size increase direction D1 in response to the inflation operation is smaller than the size increase amount of the central part 1121 of the air bag structure 112B along the size increase direction D1 in response to the inflation operation. At this time, the size of the side parts 1122 of the air bag structure 112B along the size increase direction D1 is smaller than the size of the central part 1121 of the air bag structure 112B along the size increase direction D1, such that the air bag structure 112B is adapted to guide the two legs 52 of the human body 50 on the mattress body 111 to close relatively as shown in FIG. 4B, and the two legs 52 are lowered as the air bag structure 114 contracts.

As described above, in the air mattress system 100 of this embodiment, the air bag structures 112A, 112B, and 114 expand along the up-down direction (axial direction Z) after inflation operation so as to guide the two legs 52 of the human body 50 on the mattress body 111 to be lifted and open relatively. Accordingly, it is possible to assist caregiving motions to avoid occupational injuries to caregivers and reduce the physical burden on patients.

Specifically, in this embodiment, the air bag structure 112A has a guide surface S1 (shown in FIG. 3A) extending obliquely downward from the central part 1121 to the side parts 1122 in response to the inflation operation, with the guide surface S1 continuously extending between the central part 1121 and the side parts 1122. The guide surface S1 is adapted to guide the two legs 52 of the human body 50 to open relatively as shown in FIG. 3B. Similarly, the air bag structure 112B has a guide surface S2 (shown in FIG. 4A) extending obliquely downward from the central part 1121 to the side parts 1122 in response to the inflation operation, with the guide surface S2 continuously extending between the central part 1121 and the side parts 1122. The guide surface S2 is adapted to guide the two legs 52 of the human body 50 to close relatively as shown in FIG. 4B. The guide surfaces S1 and S2 are, for example, curved surfaces. More specifically, the guide surfaces S1 and S2 are, for example, semi-cylindrical surfaces.

In this embodiment, the air mattress system 100 further includes a plurality of auxiliary air bags 116 and a plurality of corresponding air pressure valves 117 (shown in FIG. 1). The auxiliary air bags 116 are disposed on the mattress body 111. In the head-to-tail direction (axial direction X) of the mattress body 111, the air bag structures 112A and 112B are closer to the tail end 111a of the mattress body 111 than the auxiliary air bags 116. The air pressure valves 117 are respectively connected to the auxiliary air bags 116, and the controller 120 is coupled to the air pressure valves 117. The controller 120 is configured to control the air pressure valves 117 to deflate the auxiliary air bags 116, causing the auxiliary air bags 116 to contract along the up-down direction (axial direction Z) of the mattress body 111 to form an accommodation space between the auxiliary air bags 116 and the human body 50 on the mattress body 111, such that it is easier for the caregiver to perform caregiving motions on the human body 50 such as putting on and taking off clothes and/or pants and cleaning body parts contaminated by urine and feces.

Specifically, deflation may be sequentially performed on at least part of the auxiliary air bags 116 along the direction from a head end 111b to the tail end 111a of the mattress body 111, allowing the caregiver's hand to reach between the human body 50 and the auxiliary air bags 116 after deflation so as to pull down the pants worn on the human body 50. Moreover, deflation may be sequentially performed on at least part of the auxiliary air bags 116 along the direction from the tail end 111a to the head end 111b of the mattress body 111, allowing the caregiver's hand to reach between the human body 50 and the auxiliary air bags 116 after deflation so as to pull up the clothes worn on the human body 50. After pulling down the pants worn on the human body 50 and pulling up the clothes worn on the human body 50, part of the auxiliary air bags 116 may be maintained in a contracted state as shown in FIG. 3A and FIG. 3B, and then the expansion of the air bag structure 112A may be utilized as described above to cause the two legs 52 of the human body 50 to open relatively, and the expansion of the air bag structure 114 may be utilized as described above to lift the two legs 52 of the human body 50, such that it is easier for the caregiver to smoothly perform caregiving motions on the human body 50 such as putting on and removing diapers and cleaning body parts contaminated by urine and feces.

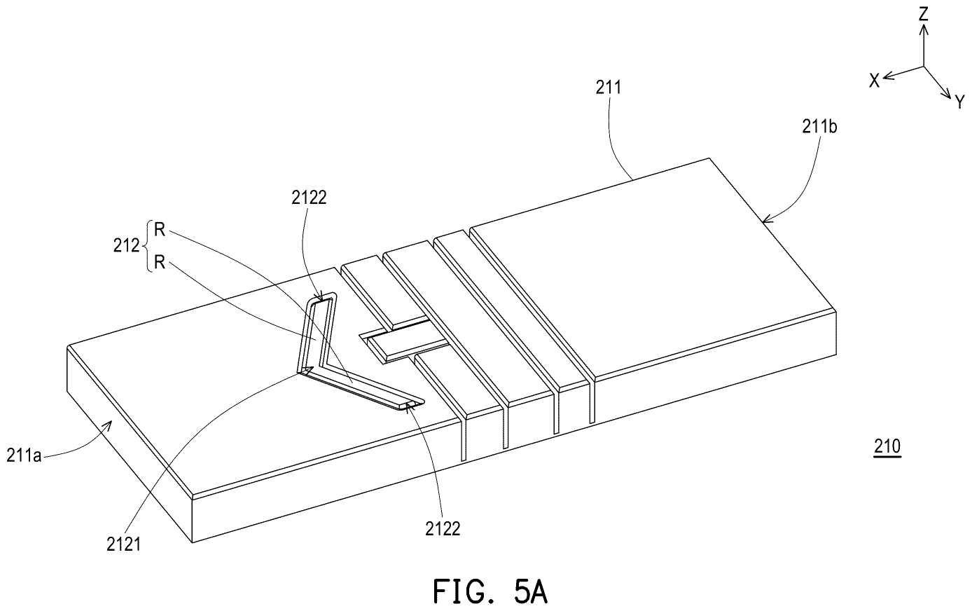

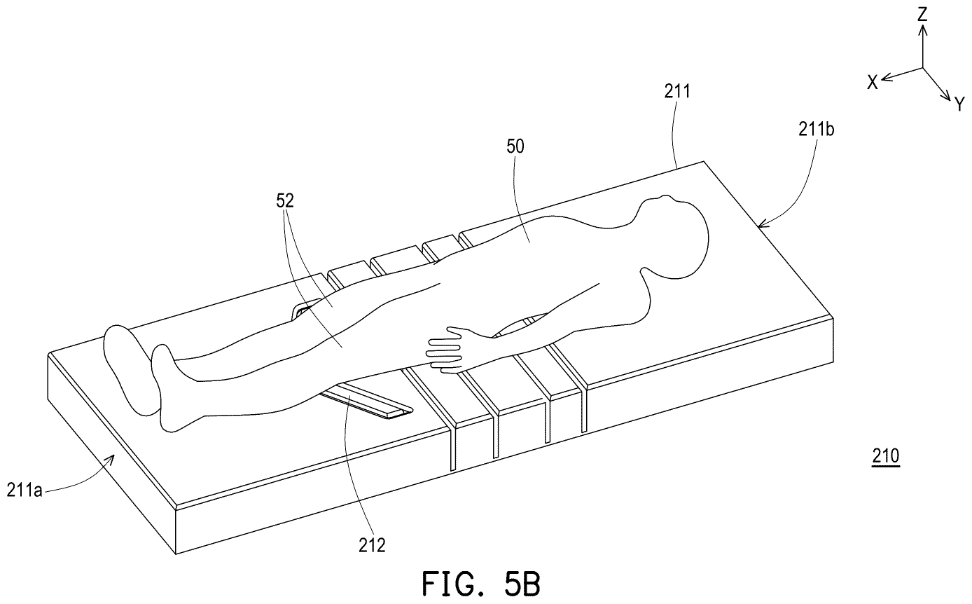

FIG. 5A is a three-dimensional view of a mattress according to another embodiment of the disclosure. FIG. 5B illustrates the mattress body of FIG. 5A carrying a human body. In a mattress 210 shown in FIG. 5A and FIG. 5B, the application of an air bag structure 212 is the same as or similar to the application of the air bag structures 112A and 112B of the embodiment shown in FIG. 1 to FIG. 4B, and the differences in operation mode are described below.

Referring to FIG. 5A and FIG. 5B, the air bag structure 212 of this embodiment has a central part 2121 and two side parts 2122, the two side parts 2122 are respectively located on opposite sides of the central part 2121 in the left-right direction (axial direction Y) of the mattress body 111.

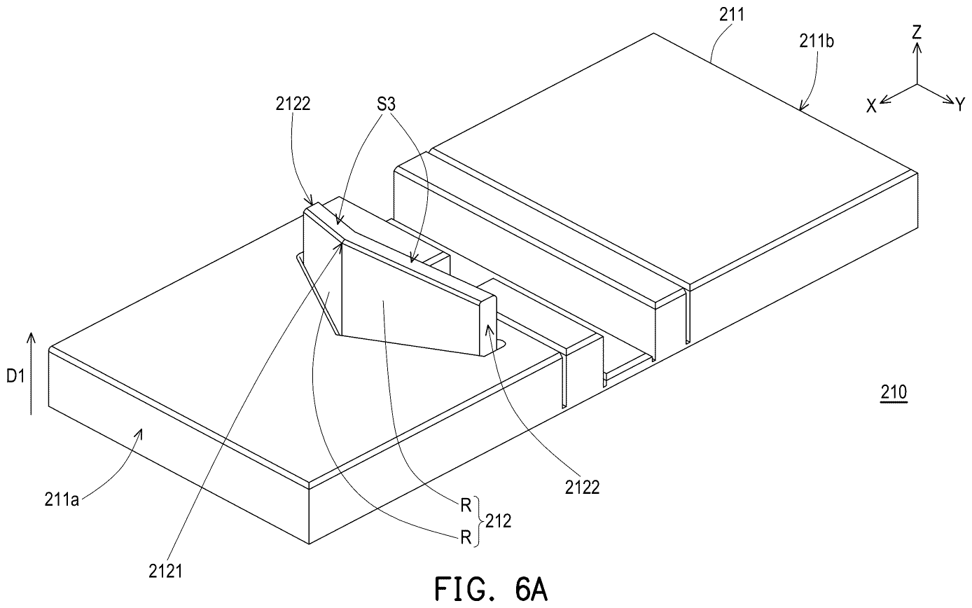

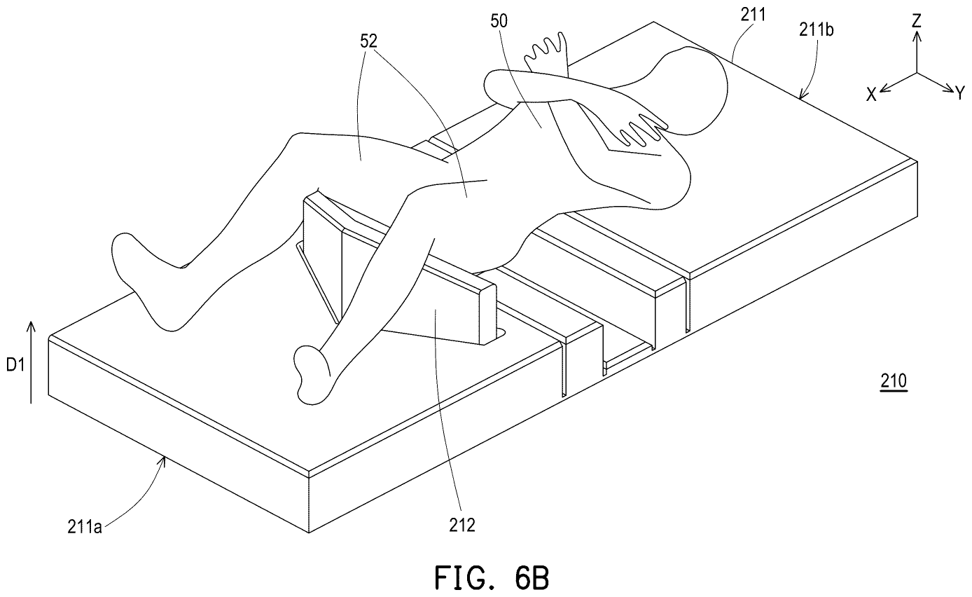

FIG. 6A and FIG. 6B respectively illustrate the air bag structure of FIG. 5A and FIG. 5B being inflated. In the initial state shown in FIG. 5A and FIG. 5B, the air bag structure 212 is, for example, flush with the surface of a mattress body 211. As shown in FIG. 6A, after the air bag structure 212 undergoes a first mode inflation operation, the air bag structure 212 expands, the size increase amount of the side parts 2122 of the air bag structure 212 along a size increase direction D1 parallel to the up-down direction (axial direction Z) of the mattress body 211 in response to the inflation operation is smaller than the size increase amount of the central part 2121 of the air bag structure 212 along the size increase direction D1 in response to the inflation operation. At this time, the size of the side parts 2122 of the air bag structure 212 along the size increase direction D1 is smaller than the size of the central part 2121 of the air bag structure 212 along the size increase direction D1, such that the air bag structure 212 is adapted to guide the two legs 52 of the human body 50 on the mattress body 211 to open relatively as shown in FIG. 6B. Accordingly, the caregiver may can perform caregiving motions on the human body 50 such as putting on and removing diapers and cleaning body parts contaminated by urine and feces.

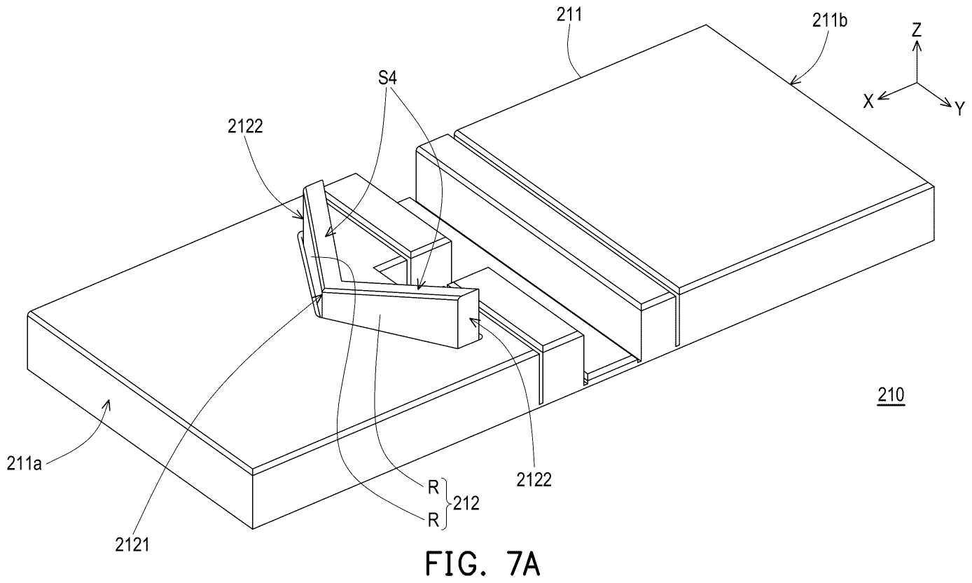

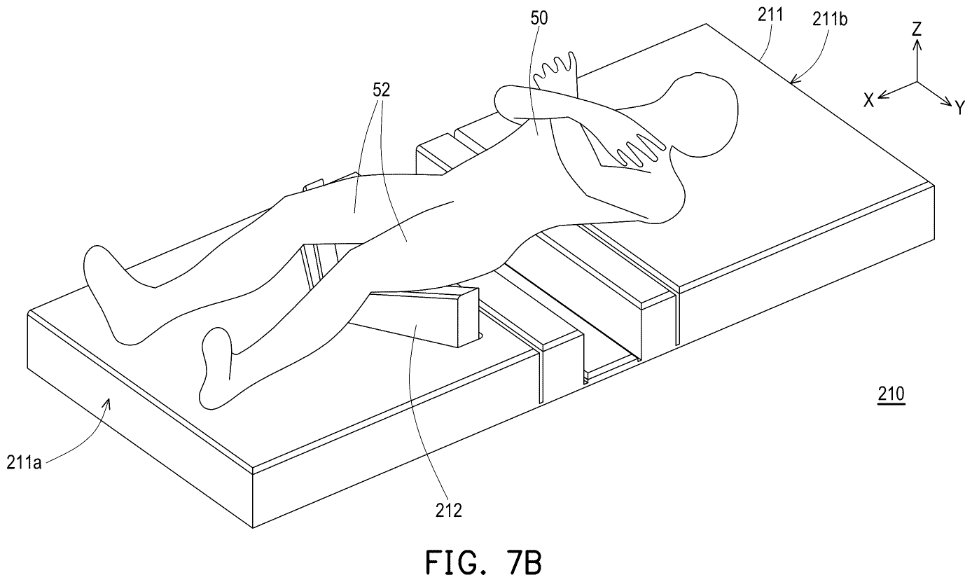

FIG. 7A and FIG. 7B respectively illustrate the air bag structure of FIG. 5A and FIG. 5B being deflated. Next, as shown in FIG. 7A, after the air bag structure 212 undergoes a second mode inflation operation, the air bag structure 212 expands in another manner, the size increase amount of the side parts 2122 of the air bag structure 212 along the size increase direction D1 in response to the inflation operation is greater than the size increase amount of the central part 2121 of the air bag structure 212 along the size increase direction D1 in response to the inflation operation. At this time, the size of the side parts 2122 of the air bag structure 212 along the size increase direction D1 is greater than the size of the central part 2121 of the air bag structure 212 along the size increase direction D1, such that the air bag structure 212 is adapted to guide the two legs 52 of the human body 50 on the mattress body 211 to close relatively as shown in FIG. 7B.

In detail, in this embodiment, the air bag structure 212 has two guide surfaces S3 (shown in FIG. 6A) extending obliquely downward from the central part 2121 to the side parts 2122 in response to the first mode inflation operation, with the guide surfaces S3 continuously extending between the central part 2121 and the side parts 2122. The two guide surfaces S3 are adapted to guide the two legs 52 of the human body 50 to open relatively as shown in FIG. 6B. In addition, the air bag structure 212 has two guide surfaces S4 (shown in FIG. 7A) extending obliquely downward from the side parts 2122 to the central part 2121 in response to the second mode inflation operation, with the guide surfaces S4 continuously extending between the central part 2121 and the side parts 2122. The two guide surfaces S4 are adapted to guide the two legs 52 of the human body 50 to close relatively as shown in FIG. 7B. The guide surfaces S3, S4 are, for example, inclined surfaces.

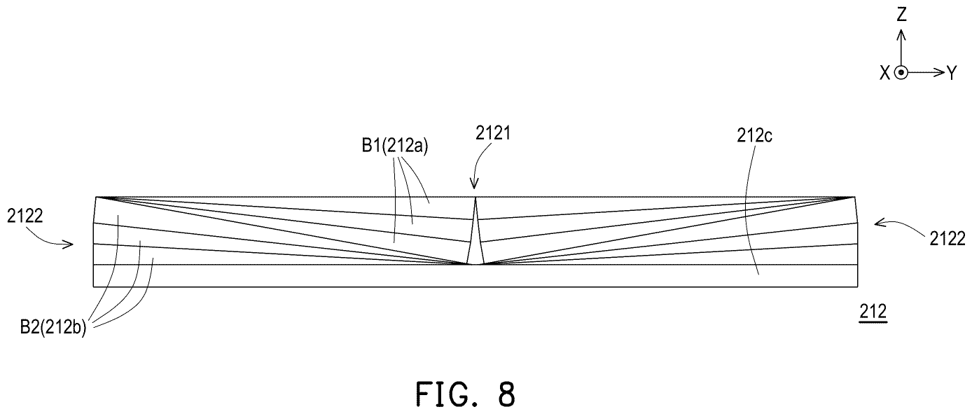

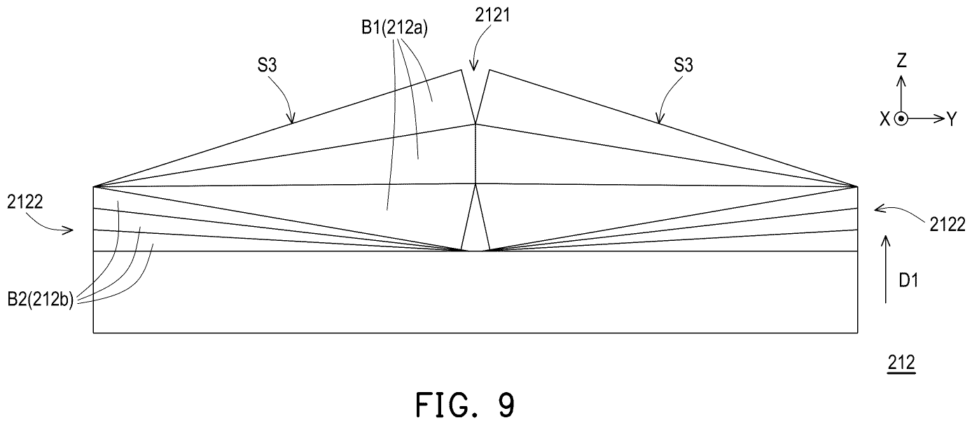

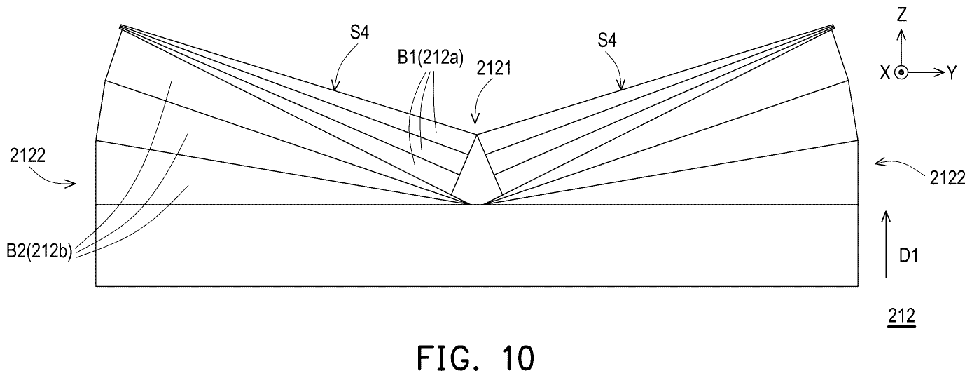

FIG. 8 to FIG. 10 are respectively schematic views of the air bag structure of FIG. 5A, FIG. 6A, FIG. 7A. More specifically, the air bag structure 212 has at least two air bag parts: 212a and 212b as shown in FIG. 8, and the two air bag parts: 212a and 212b are adjacent to each other but not interconnected. The first mode inflation operation inflates the air bag part 212a as shown in FIG. 9 such that the size increase amount of the side parts 2122 along the size increase direction D1 in response to the inflation operation is smaller than the size increase amount of the central part 2121 along the size increase direction D1 in response to the inflation operation. The second mode inflation operation inflates the air bag part 212b as shown in FIG. 10 such that the size increase amount of the side parts 2122 along the size increase direction D1 in response to the inflation operation is greater than the size increase amount of the central part 2121 along the size increase direction D1 in response to the inflation operation. Moreover, the air bag structure 212 may further include a bottom air bag 212c, and the bottom air bag 212c may be inflated as shown in FIG. 9 and FIG. 10 to increase the overall height of the air bag structure 212.

Furthermore, the air bag part 212a has a plurality of first sub-air bag parts B1. The first sub-air bag parts B1 are sequentially stacked along the up-down direction (axial direction Z) of the mattress body 211 (shown in FIG. 5A), and the expandable degree of one end of each of the first sub-air bag parts B1 located at the central part 2121 is greater than the expandable degree of one end of each of the first sub-air bag parts B1 located at the side parts 2122. Thus, when the air bag part 212a is inflated, it may have a larger size increase amount at the central part 2121. Similarly, the air bag part 212b has a plurality of second sub-air bag parts B2. The second sub-air bag parts B2 are sequentially stacked along the up-down direction (axial direction Z) of the mattress body 211 (shown in FIG. 5A), and the expandable degree of one end of each of the second sub-air bag parts B2 located at the central part 2121 is smaller than the expandable degree of one end of each of the second sub-air bag parts B2 located at the side parts 2122. Thus, when the air bag part 212b is inflated, it may have a larger size increase amount at the side parts 2122.

As shown in FIG. 5A, FIG. 6A and FIG. 7A, the air bag structure 212 of this embodiment includes two blocks R, the two blocks R respectively correspond to two guide surfaces S3 (two guide surfaces S4). When observed along the up-down direction (axial direction Z) of the mattress body 211, each block R extends along a direction inclined to the left-right direction (axial direction Y) of the mattress body 211 to make the air bag structure 212 V-shaped. More specifically, the tip of the V-shape faces toward a tail end 211a of the mattress body 211, and the opening end of the V-shape faces toward a head end 211b of the mattress body 211. Accordingly, the air bag structure 212 shown in FIG. 6B may guide the legs 52 of the human body 50 to open in accordance with the swinging direction of the legs 52 when they open, so as to prevent the human body 50 from feeling discomfort or injured due to unsmooth guidance of the air bag structure 212.

As shown in FIG. 6B, the air bag structure 212 of this embodiment further guides the two legs 52 of the human body 50 on the mattress body 211 to be lifted in response to the inflation operation. Accordingly, the mattress body 211 of this embodiment does not need to additionally include the air bag structure 114 for lifting the legs 52 as shown in FIG. 3B.

The rest of the configurations and operation modes of the mattress 210 and the corresponding air mattress system shown in FIG. 5A to FIG. 7B are the same or similar to those of the embodiment shown in FIG. 1 to FIG. 4B, and will not be described in detail here.

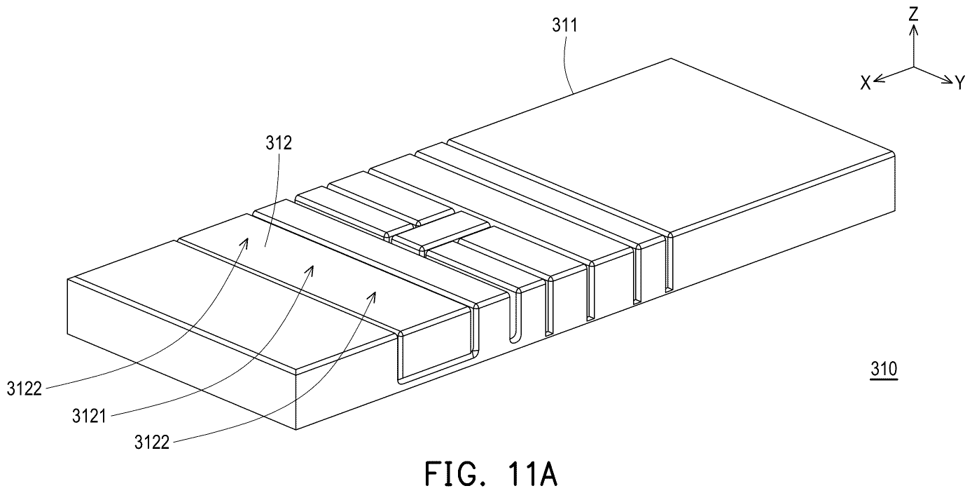

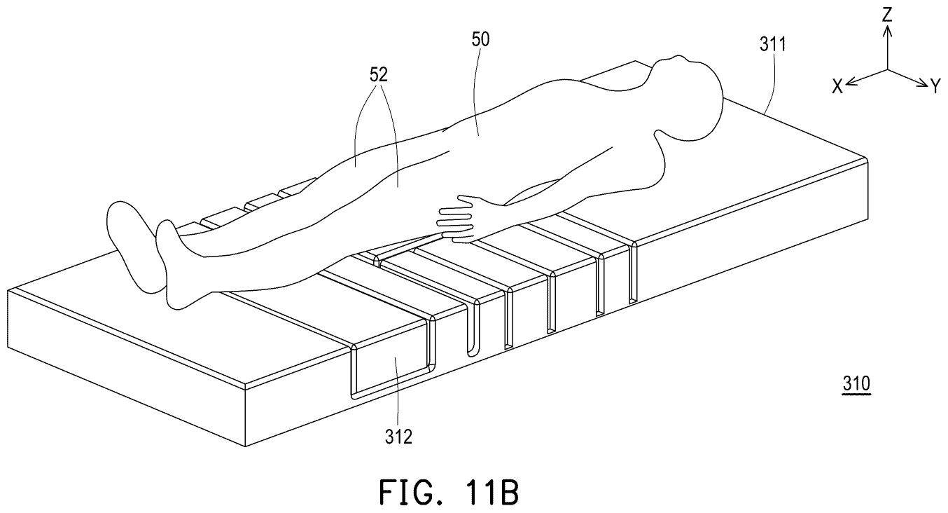

FIG. 11A is a three-dimensional view of a mattress of another embodiment of the disclosure. FIG. 11B illustrates the mattress body of FIG. 11A carrying a human body. In a mattress 310 shown in FIG. 11A and FIG. 11B, the application of an air bag structure 312 is the same or similar to the application of the air bag structures 112A and 112B of the embodiment shown in FIG. 1 to FIG. 4B, and the differences in operation modes are described below.

Referring to FIG. 11A and FIG. 11B, the air bag structure 312 of this embodiment has a central part 3121 and two side parts 3122, and the two side parts 3122 are respectively located on opposite sides of the central part 3121 in the left-right direction (axial direction Y) of a mattress body 311.

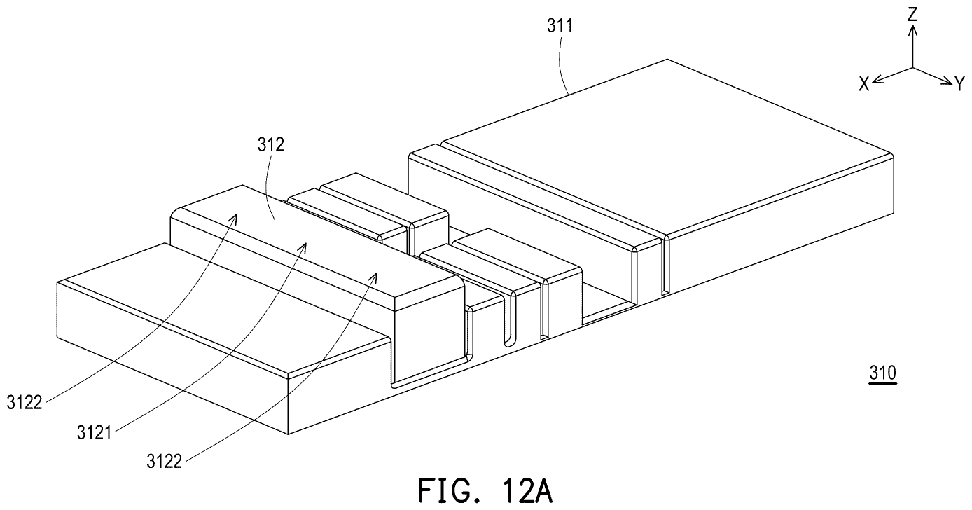

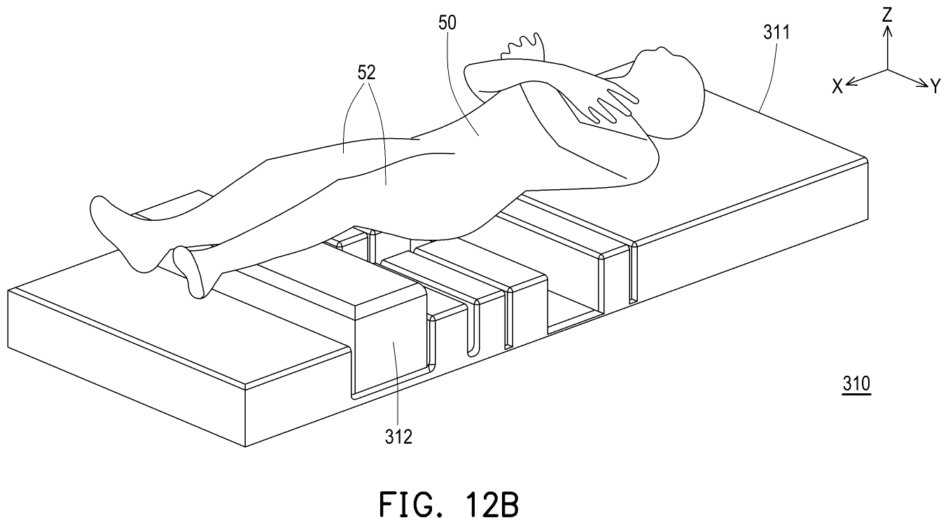

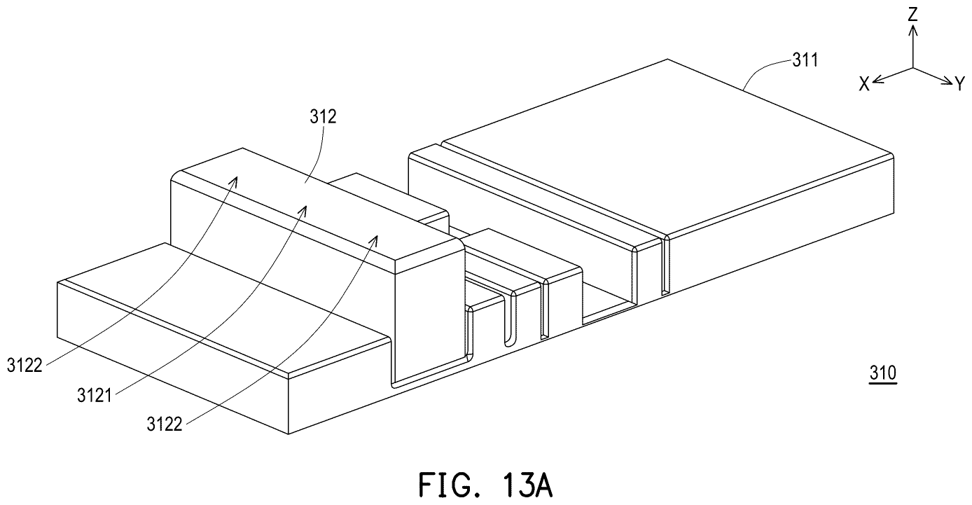

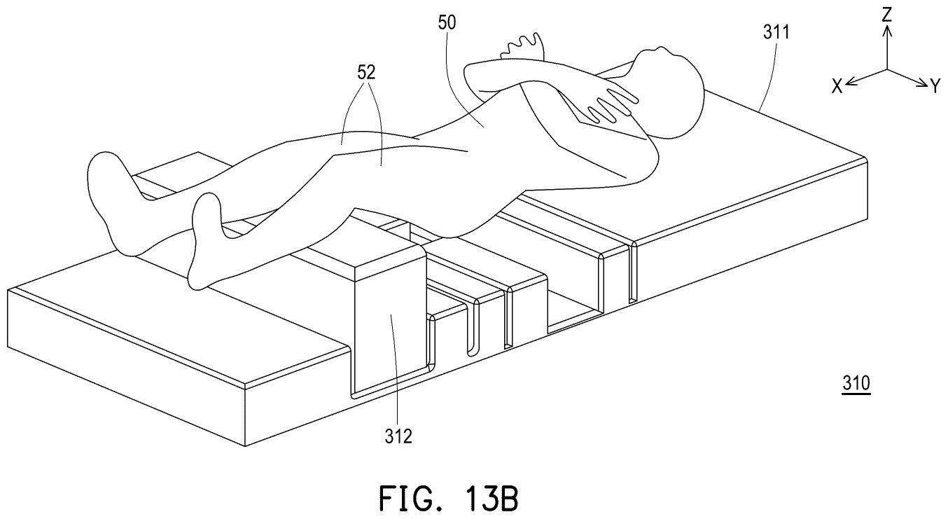

FIG. 12A and FIG. 12B respectively illustrate the air bag structure of FIG. 11A and FIG. 11B being inflated. FIG. 13A and FIG. 13B respectively illustrate the air bag structure of FIG. 12A and FIG. 12B being further inflated. In the initial state shown in FIG. 11A and FIG. 11B, the air bag structure 312 is, for example, flush with the surface of the mattress body 311. As shown in FIG. 12A, after the air bag structure 312 undergoes the first mode inflation operation, the air bag structure 312 uniformly expands to lift the legs 52 of the human body 50 as shown in FIG. 12B. As shown in FIG. 13A, after the air bag structure 312 undergoes the second mode inflation operation based on the first mode inflation operation, the air bag structure 312 further uniformly expands to further lift the legs 52 of the human body 50 as shown in FIG. 13B.

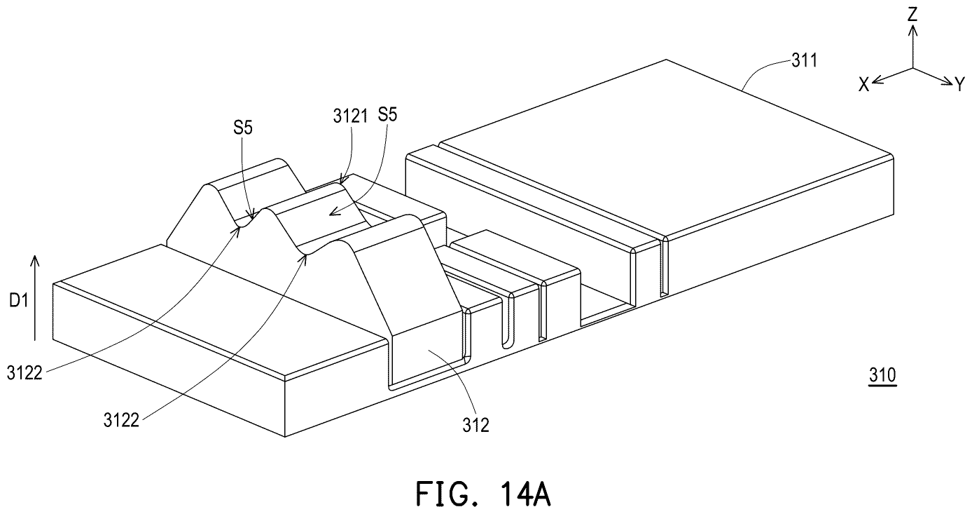

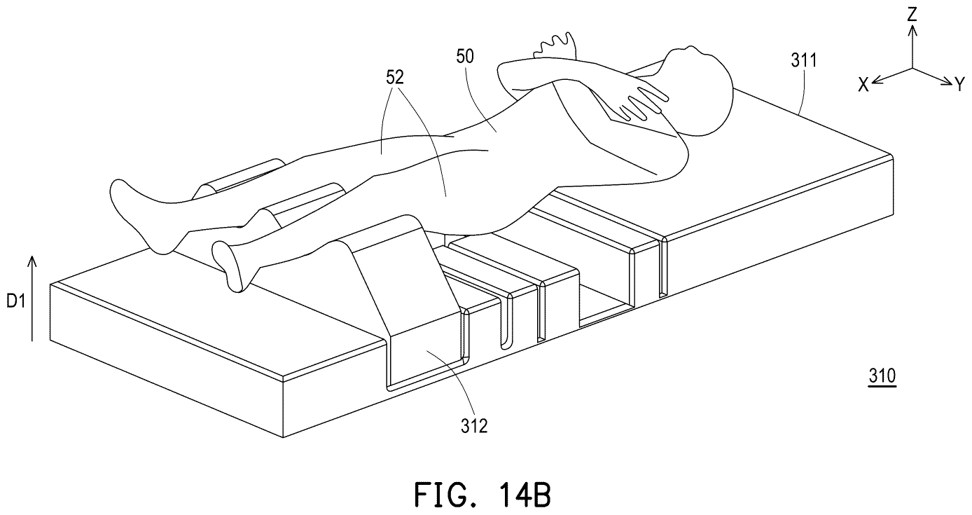

FIG. 14A and FIG. 14B respectively illustrate the air bag structure of FIG. 13A and FIG. 13B being deformed. As shown in FIG. 14A, after the air bag structure 312 undergoes a third mode inflation operation based on the second mode inflation operation, the air bag structure 312 is deformed. Based on the initial state shown in FIG. 11A, the size increase amount of the side parts 3122 of the air bag structure 312 along a size increase direction D1 parallel to the up-down direction (axial direction Z) of the mattress body 311 in response to the inflation operation shown in FIG. 14A is smaller than the size increase amount of the central part 3121 of the air bag structure 312 along the size increase direction D1 in response to the inflation operation shown in FIG. 14A. At this time, the size of the side parts 3122 of the air bag structure 312 along the size increase direction D1 is smaller than the size of the central part 3121 of the air bag structure 312 along the size increase direction D1, such that the air bag structure 312 is adapted to guide the two legs 52 of the human body 50 on the mattress body 311 to open relatively as shown in FIG. 14B. Accordingly, it is easier for the caregiver to perform caregiving motions such as putting on and removing diapers on the human body 50.

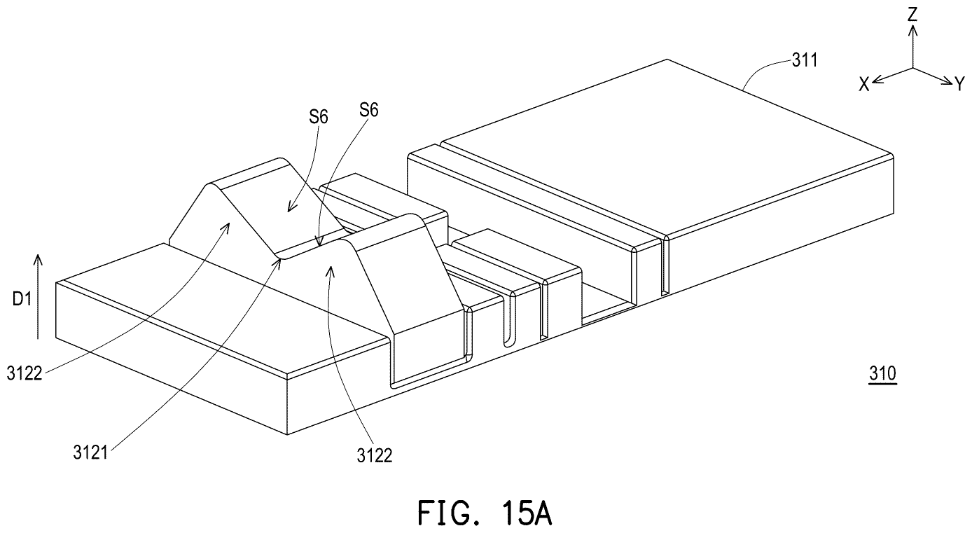

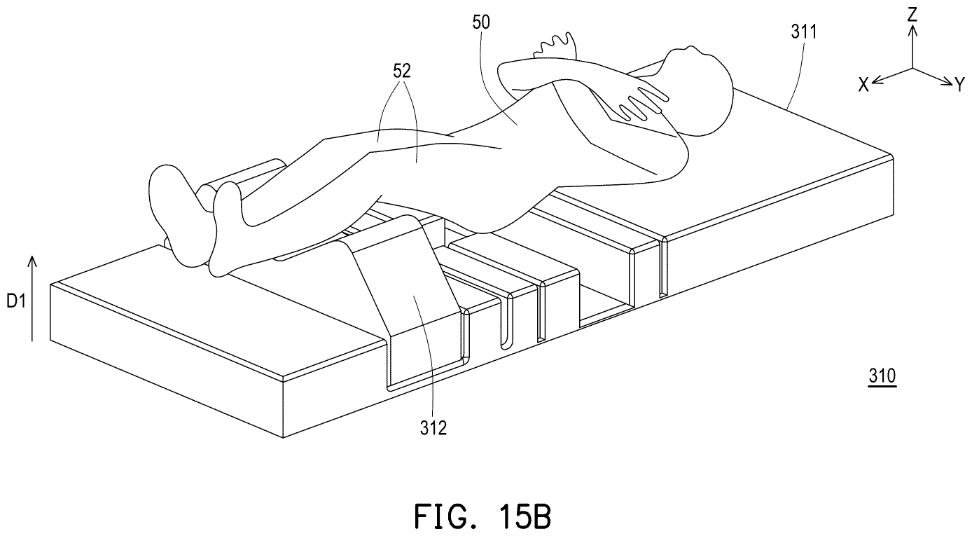

FIG. 15A and FIG. 15B respectively illustrate the air bag structure of FIG. 14A and FIG. 14B being deformed. Next, as shown in FIG. 15A, after the air bag structure 312 undergoes a fourth mode inflation operation based on the third mode inflation operation, the air bag structure 312 is deformed in another way. Based on the initial state shown in FIG. 11A, the size increase amount of the side parts 3122 of the air bag structure 312 along the size increase direction D1 in response to the inflation operation shown in FIG. 15A is smaller than the size increase amount of the central part 3121 of the air bag structure 312 along the size increase direction D1 in response to the inflation operation shown in FIG. 15A. At this time, the size of the side parts 3122 of the air bag structure 312 along the size increase direction D1 is smaller than the size of the central part 3121 of the air bag structure 312 along the size increase direction D1, such that the air bag structure 312 is adapted to guide the two legs 52 of the human body 50 on the mattress body 311 to close relatively as shown in FIG. 15B.

In detail, in this embodiment, the air bag structure 312 has two guide surfaces S5 (shown in FIG. 14A) extending obliquely downward from the central part 3121 to the side parts 3122 in response to the third mode inflation operation, with the guide surfaces S5 continuously extending between the central part 3121 and the side parts 3122. The two guide surfaces S5 are adapted to guide the two legs 52 of the human body 50 to open relatively as shown in FIG. 14B. In addition, the air bag structure 312 has two guide surfaces S6 (shown in FIG. 15A) extending obliquely downward from the side parts 3122 to the central part 3121 in response to the fourth mode inflation operation, with the guide surfaces S6 continuously extending between the central part 3121 and the side parts 3122. The two guide surfaces S6 are adapted to guide the two legs 52 of the human body 50 to close relatively as shown in FIG. 15B. The guide surfaces S5 and S6 are, for example, inclined surfaces.

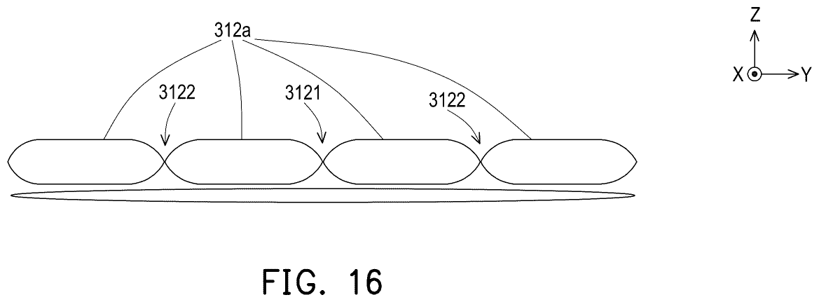

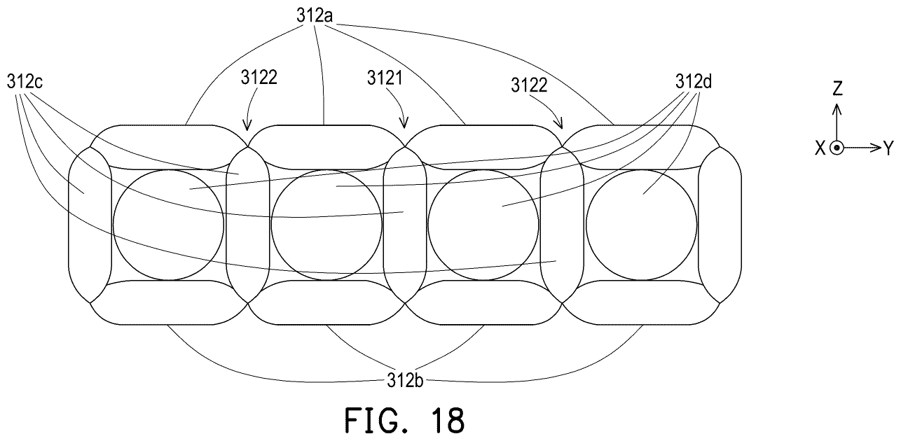

FIG. 16 to FIG. 20 are respectively schematic views of the air bag structures of FIG. 11A, FIG. 12A, FIG. 13A, FIG. 14A, and FIG. 15A. More specifically, the air bag structure 312 has a plurality of air bag parts 312a, 312b, 312c, 312d that are adjacent to each other but not interconnected as shown in FIG. 18. The air bag parts 312a are located at the uppermost layer, the air bag parts 312b are located at the lowermost layer, the air bag parts 312c are connected between the air bag parts 312a and the air bag parts 312b and are located at the middle layer, and the air bag parts 312d are surrounded by the air bag parts 312a, 312b, 312c and are located at the middle layer.

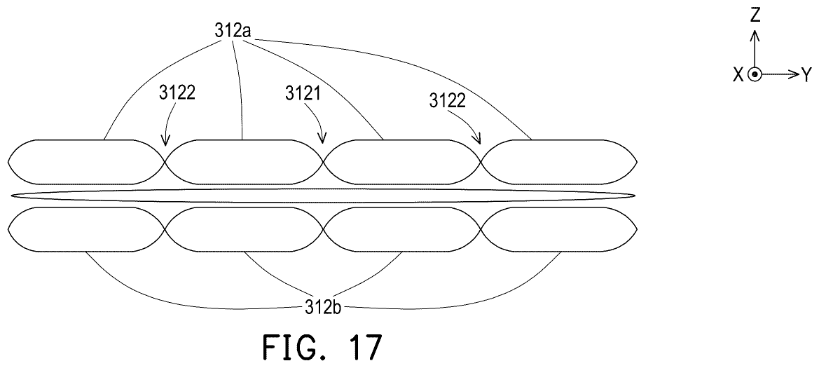

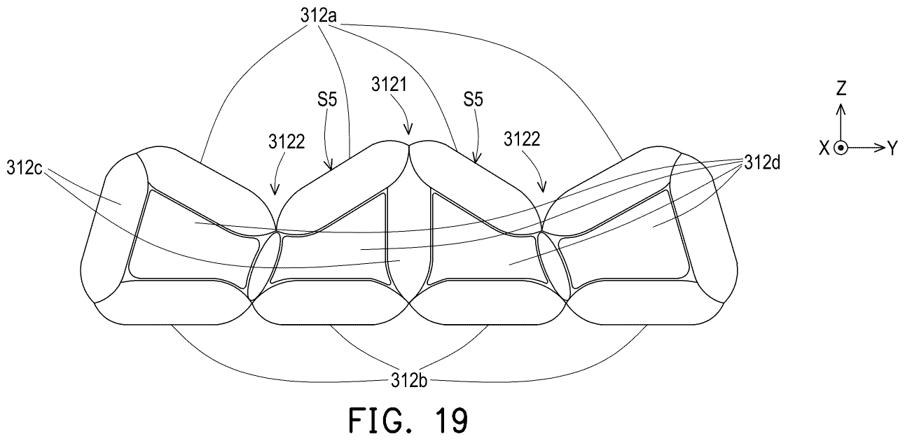

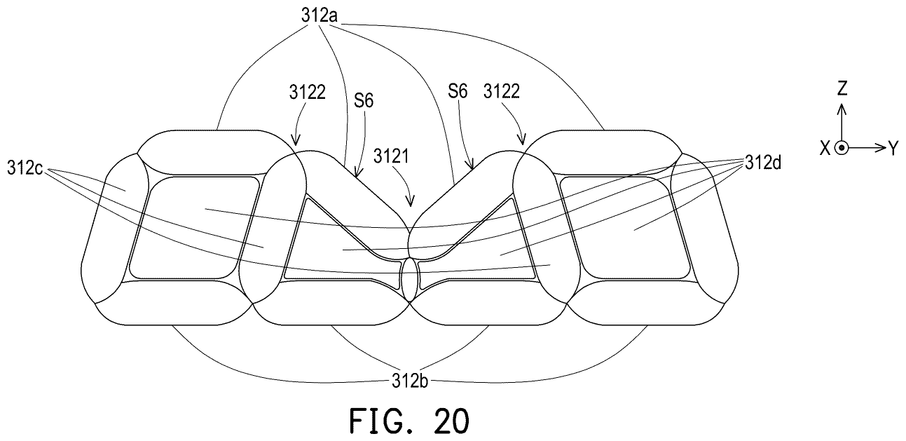

In the initial state shown in FIG. 16, the air bag parts 312a are in an inflated state, and the air bag parts 312b, 312c, 312d are in an uninflated state. Under the first mode inflation operation shown in FIG. 17, the air bag parts 312a, 312b are in an inflated state, and the air bag parts 312c, 312d are in an uninflated state. Under the second mode inflation operation shown in FIG. 18, the air bag parts 312a, 312b, 312c, 312d are in an inflated state. Under the third mode inflation operation shown in FIG. 19, the air bag parts 312a, 312b, 312d are in an inflated state, those of the air bag parts 312c located at the side parts 3122 are in an uninflated state, and the rest of the air bag parts 312c are in an inflated state. Under the fourth mode inflation operation shown in FIG. 20, the air bag parts 312a, 312b, 312d are in an inflated state, those of the air bag parts 312c located at the central part 3121 are in an uninflated state, and the rest of the air bag parts 312c are in an inflated state. Through the variations in the inflated states of the air bag parts 312a, 312b, 312c, 312d, the air bag structure 312 may be transformed into various configurations as shown in FIG. 11A, FIG. 12A, FIG. 13A, FIG. 14A, and FIG. 15A.

The rest of the configurations and operation modes of the mattress 310 and the corresponding air mattress system shown in FIG. 11A to FIG. 15B are the same or similar to those of the embodiment shown in FIG. 1 to FIG. 4B, and will not be described in detail here.

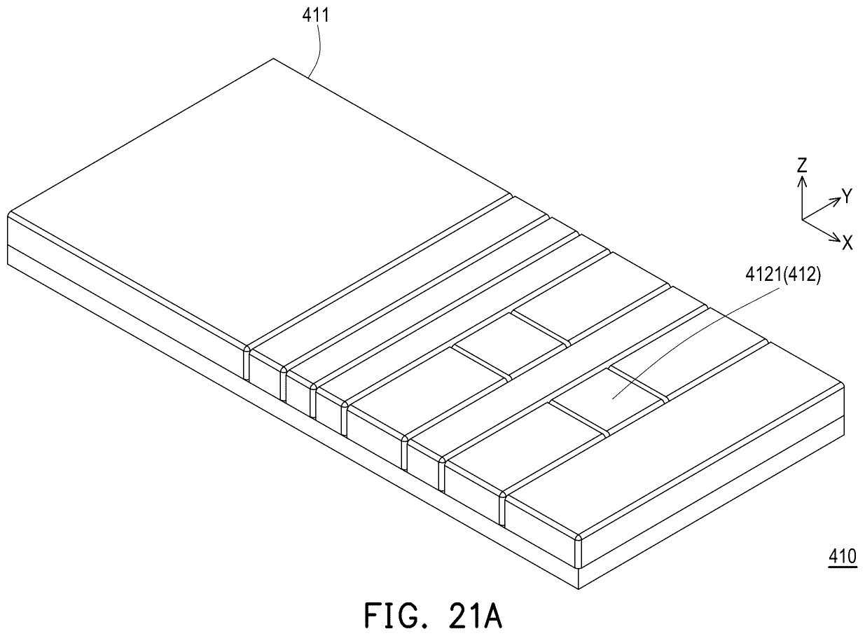

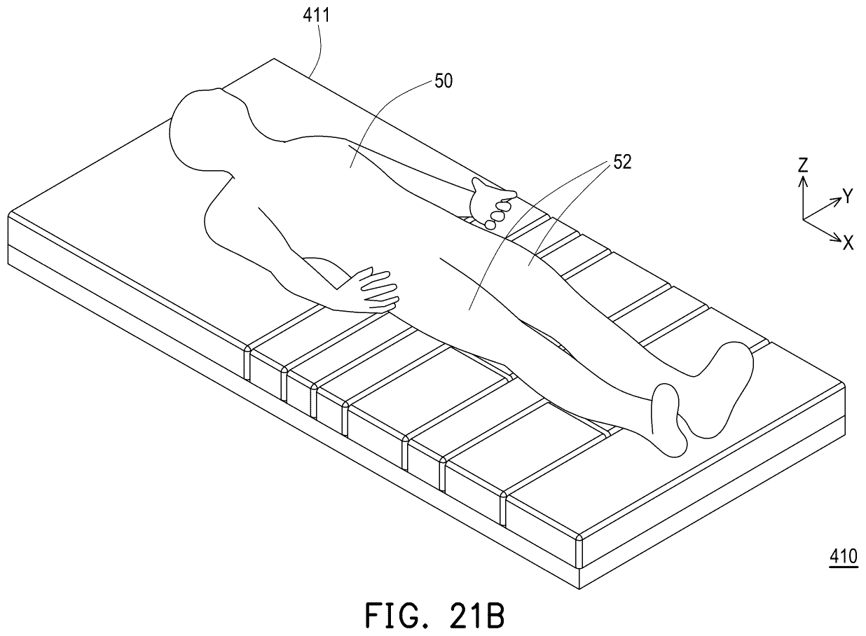

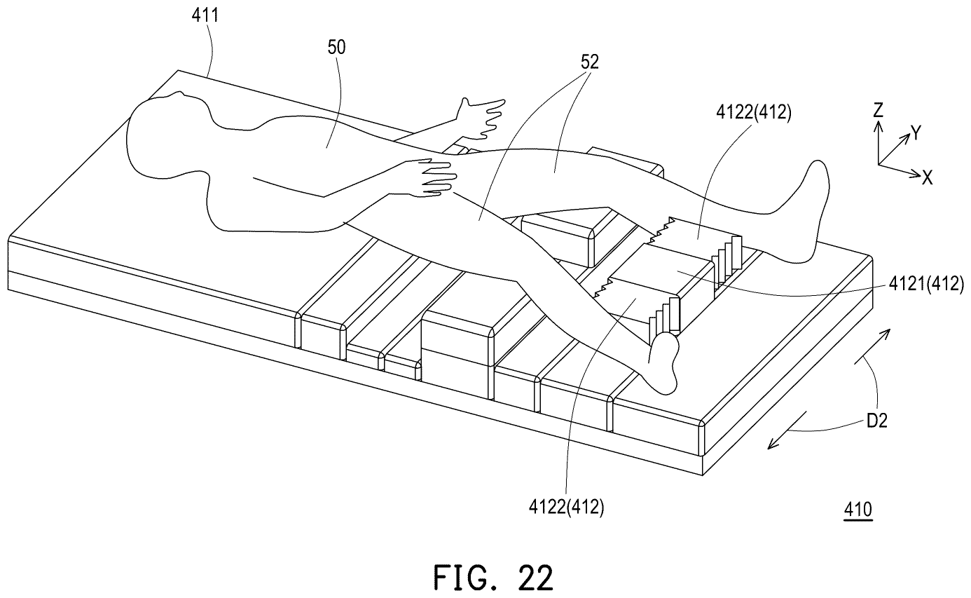

FIG. 21A is a three-dimensional view of a mattress of another embodiment of the disclosure. FIG. 21B illustrates the mattress body of FIG. 21A carrying a human body. FIG. 22 illustrates the air bag structure of FIG. 21B being inflated. In a mattress 410 shown in FIG. 21A and FIG. 21B, the application of an air bag structure 412 is the same or similar to the application of the air bag structure 112A of the embodiment shown in FIG. 1 to FIG. 4B, and the differences in its operation mode are described below.

Referring to FIG. 21A and FIG. 22, the air bag structure 412 of this embodiment has a central part 4121 and two side parts 4122, with the two side parts 4122 respectively located on opposite sides of the central part 4121 in the left-right direction (axial direction Y) of a mattress body 411.

In the initial state shown in FIG. 21A and FIG. 21B, the air bag structure 412 is, for example, flush with the surface of the mattress body 411. As shown in FIG. 22, after the air bag structure 412 is inflated, the central part 4121 of the air bag structure 412 expands upward, and the side parts 4122 of the air bag structure 412 rise accordingly and expand toward the left and right sides respectively. The central part 4121 does not have a size increase amount in a size increase direction D2 parallel to the left-right direction (axial direction Y) of the mattress body 411, while the side parts 4122 of the air bag structure 412 have a size increase amount in the size increase direction D2. That is, the size increase amount of the side parts 4122 of the air bag structure 412 along the size increase direction D2 in response to the inflation operation is greater than the size increase amount of the central part 4121 of the air bag structure 412 along the size increase direction D2 in response to the inflation operation. Accordingly, the air bag structure 412 is adapted to push the two legs 52 of the human body 50 on the mattress body 411 along the size increase direction D2 as shown in FIG. 22 so as to guide the two legs 52 to open relatively. Accordingly, it is easier for the caregiver to perform caregiving motions such as putting on and removing diapers on the human body 50.

The rest of the configurations and operation modes of the mattress 410 and the corresponding air mattress system shown in FIG. 21A to FIG. 22 are the same or similar to those of the embodiment shown in FIG. 1 to FIG. 4B, and will not be described in detail here.

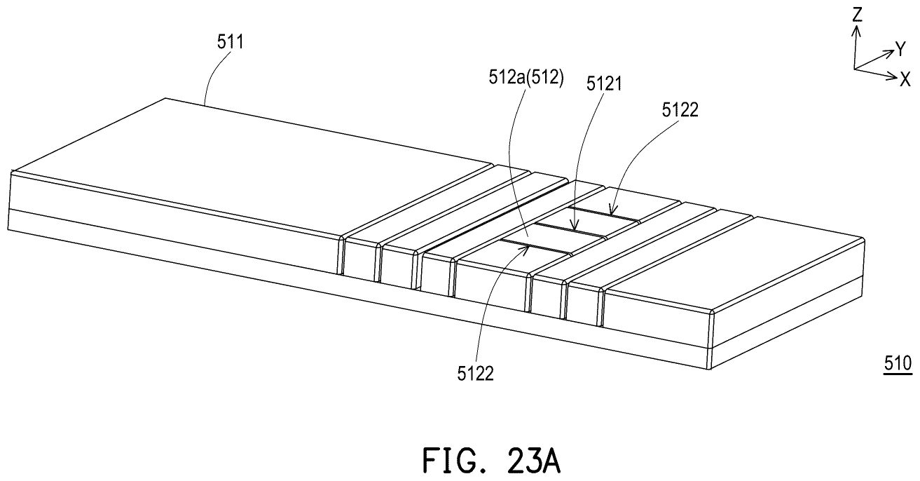

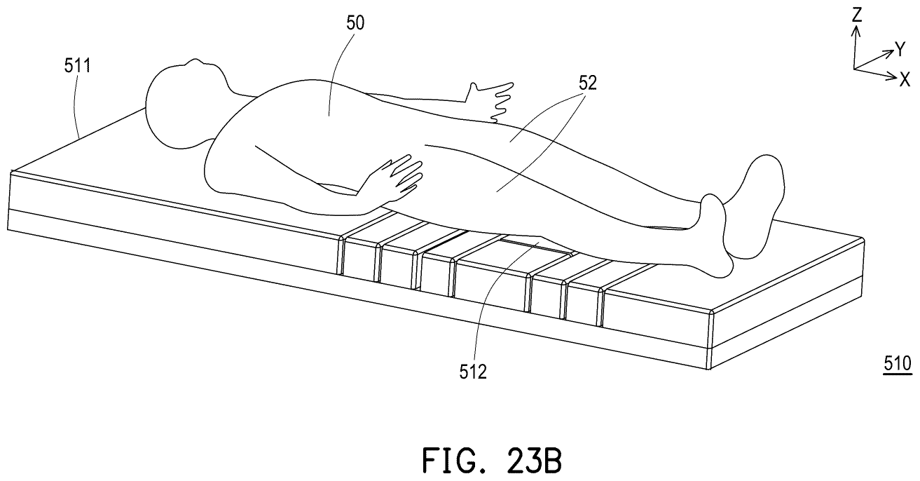

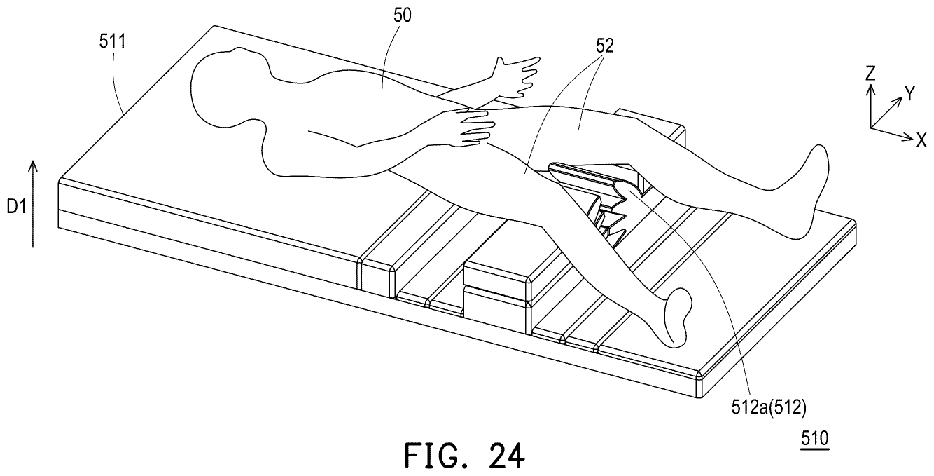

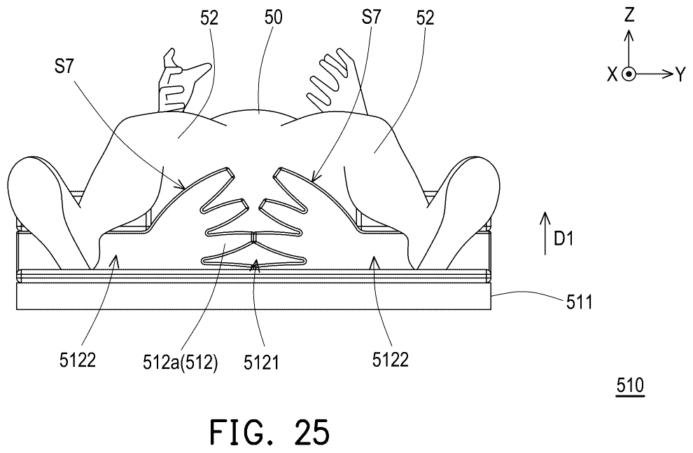

FIG. 23A is a three-dimensional view of a mattress of another embodiment of the disclosure. FIG. 23B illustrates the mattress body of FIG. 23A carrying a human body. FIG. 24 illustrates the air bag structure of FIG. 23B being inflated. FIG. 25 is a front view of the mattress of FIG. 24. In a mattress 510 shown in FIG. 23A and FIG. 23B, the application of an air bag structure 512 is the same or similar to the application of the air bag structure 112A of the embodiment shown in FIG. 1 to FIG. 4B, and the differences in its operation mode are described below.

Referring to FIG. 23A, the air bag structure 512 of this embodiment has a central part 5121 and two side parts 5122, with the two side parts 5122 respectively located on opposite sides of the central part 5121 in the left-right direction (axial direction Y) of a mattress body 511.

In the initial state shown in FIG. 23A and FIG. 23B, the air bag structure 512 is, for example, flush with the surface of the mattress body 511. As shown in FIG. 24 and FIG. 25, after the air bag structure 512 is inflated, the air bag structure 512 expands, and the size increase amount of the side parts 5122 of the air bag structure 512 along a size increase direction D1 parallel to the up-down direction (axial direction Z) of the mattress body 511 in response to the inflation operation is smaller than the size increase amount of the central part 5121 of the air bag structure 512 along the size increase direction D1 in response to the inflation operation. Accordingly, the air bag structure 512 is adapted to guide the two legs 52 to open relatively as shown in FIG. 24 and FIG. 25. Accordingly, it is easier for the caregiver to perform caregiving motions such as putting on and removing diapers on the human body 50.

In detail, in this embodiment, the air bag structure 512 has two guide surfaces S7 (shown in FIG. 25) extending obliquely downward from the central part 5121 to the side parts 5122 in response to the inflation operation, with the guide surfaces S7 continuously extending between the central part 5121 and the side parts 5122. The two guide surfaces S7 are adapted to guide the two legs 52 of the human body 50 to open relatively as shown in FIG. 24 and FIG. 25. The guide surfaces S7 are, for example, curved surfaces.

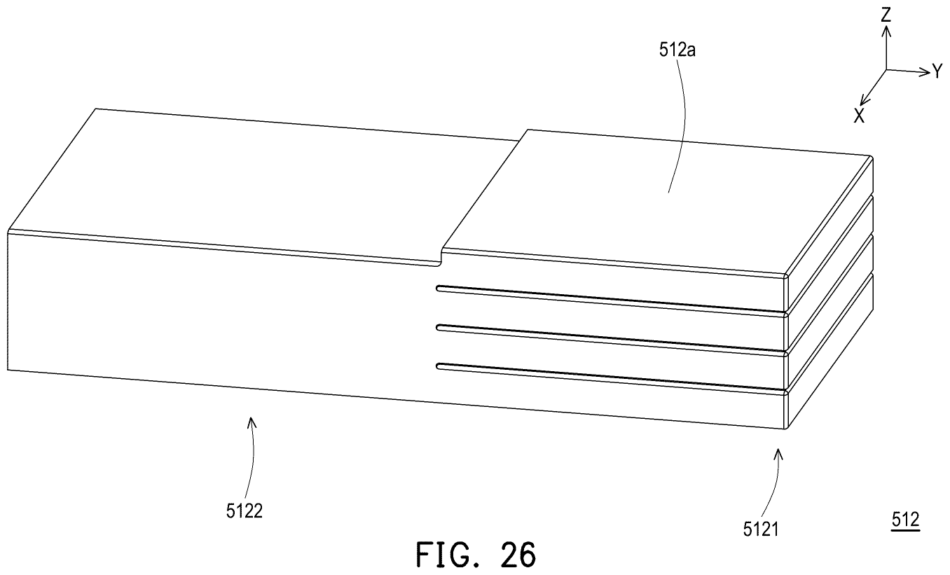

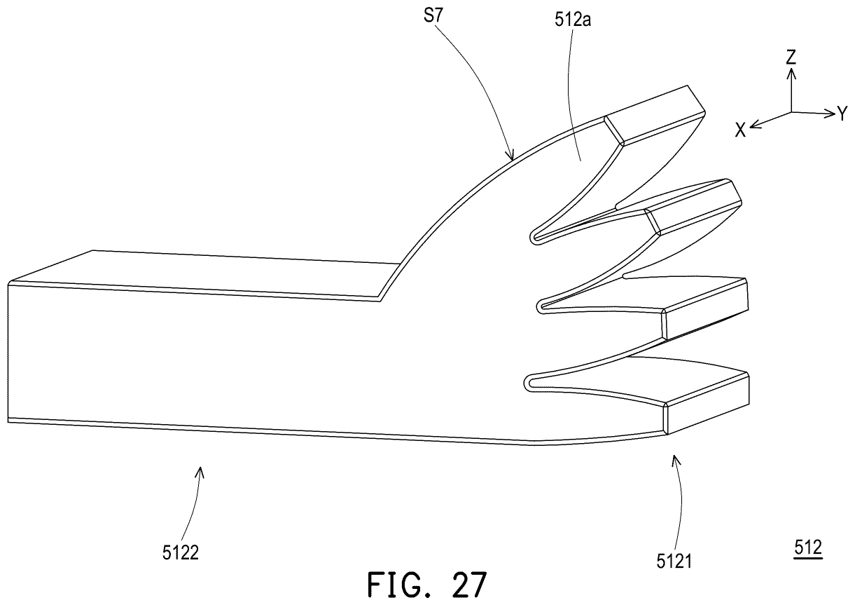

FIG. 26 is a three-dimensional view of the local air bag structure of FIG. 23A. FIG. 27 is a three-dimensional view of the local air bag structure of FIG. 24. Referring to FIG. 26 and FIG. 27, specifically, the air bag structure 512 of this embodiment has a plurality of branch parts 512a. The branch parts 512a are sequentially stacked along the up-down direction (axial direction Z) of the mattress body 511, and the branch parts 512a are connected to each other at the side parts 5122 and separated from each other at the central part 5121. Accordingly, in a case where the air bag structure 512 is inflated, the branch parts 512a expand upward at the central part 5121 with a greater degree of expansion, such that the air bag structure 512 as a whole becomes the configuration shown in FIG. 24 and FIG. 25.

The rest of the configurations and operation modes of the mattress 510 and the corresponding air mattress system shown in FIG. 23A to FIG. 24 are the same or similar to those of the embodiment shown in FIG. 1 to FIG. 4B, and will not be described in detail here.

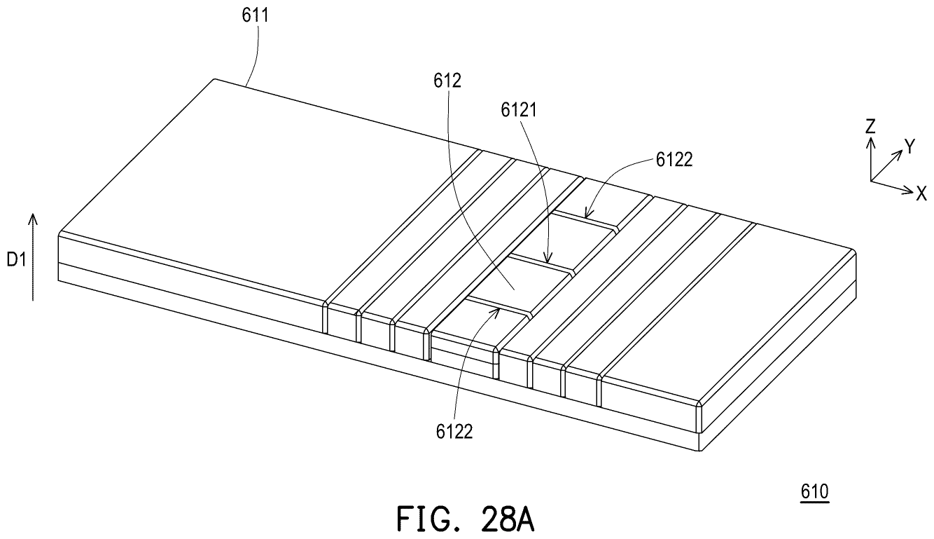

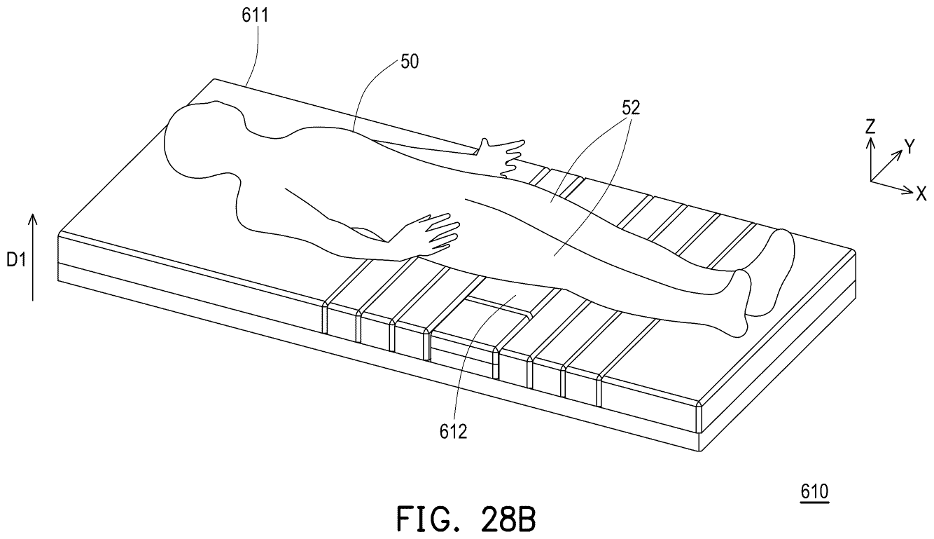

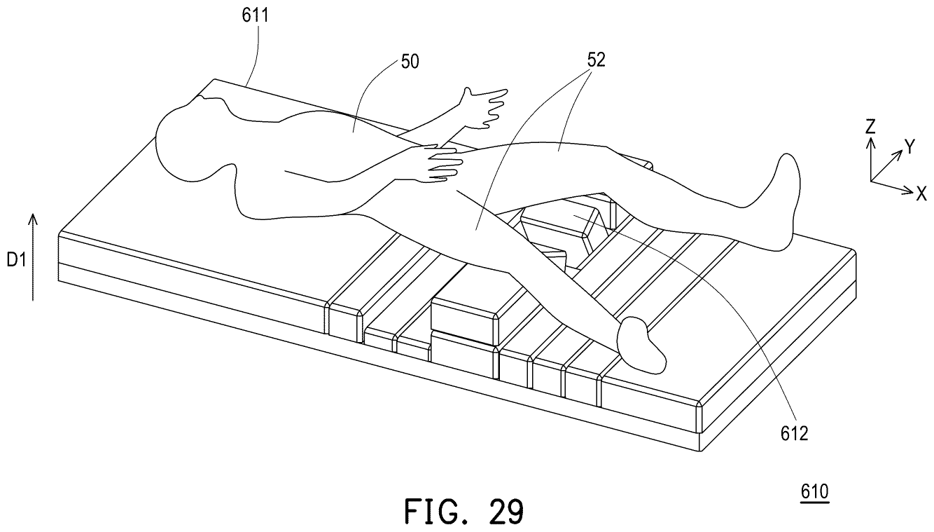

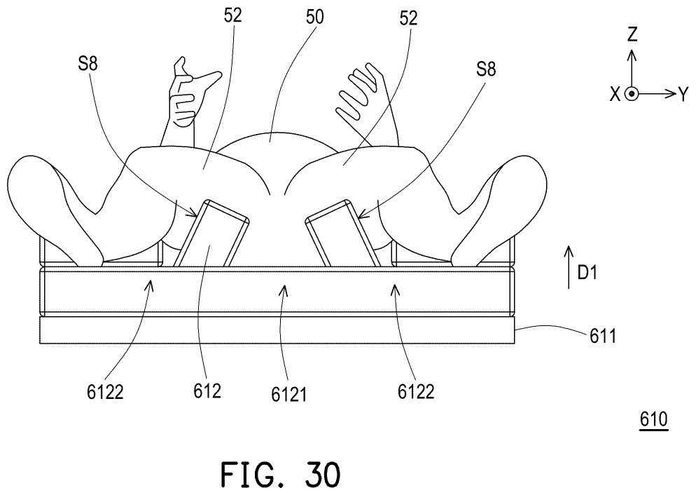

FIG. 28A is a three-dimensional view of a mattress of another embodiment of the disclosure. FIG. 28B illustrates the mattress body of FIG. 28A carrying a human body. FIG. 29 illustrates the air bag structure of FIG. 28B being inflated. FIG. 30 is a front view of the mattress of FIG. 29. In a mattress 610 shown in FIG. 28A and FIG. 28B, the application of an air bag structure 612 is the same or similar to the application of the air bag structure 112A of the embodiment shown in FIG. 1 to FIG. 4B, and the differences in operation mode are described below.

Referring to FIG. 28A, the air bag structure 612 of this embodiment has a central part 6121 and two side parts 6122, with the two side parts 6122 respectively located on opposite sides of the central part 6121 in the left-right direction (axial direction Y) of a mattress body 611.

In the initial state shown in FIG. 28A and FIG. 28B, the air bag structure 612 is, for example, flush with the surface of the mattress body 611. As shown in FIG. 29 and FIG. 30, after the air bag structure 612 is inflated, the air bag structure 612 expands, and the size increase amount of the side parts 6122 of the air bag structure 612 along a size increase direction D1 parallel to the up-down direction (axial direction Z) of the mattress body 611 in response to the inflation operation is smaller than the size increase amount of the central part 6121 of the air bag structure 612 along the size increase direction D1 in response to the inflation operation. Accordingly, the air bag structure 612 is adapted to guide the two legs 52 to open relatively as shown in FIG. 29 and FIG. 30. Accordingly, it is easier for the caregiver to perform caregiving motions such as putting on and removing diapers on the human body 50.

In detail, in this embodiment, the air bag structure 612 has two guide surfaces S8 (shown in FIG. 30) extending obliquely downward from the central part 6121 to the side parts 6122 in response to the inflation operation, with the guide surfaces S8 continuously extending between the central part 6121 and the side parts 6122. The two guide surfaces S8 are adapted to guide the two legs 52 of the human body 50 to open relatively as shown in FIG. 29 and FIG. 30. The guide surfaces S8 are, for example, inclined surfaces.

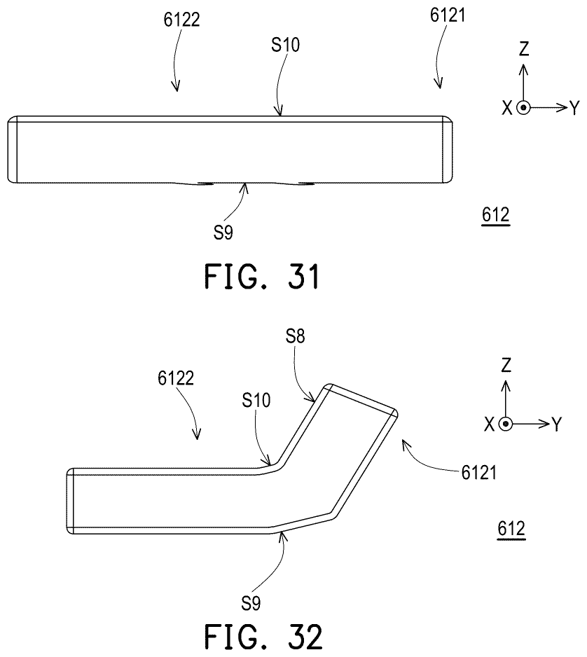

FIG. 31 is a three-dimensional view of the local air bag structure of FIG. 28A. FIG. 32 is a three-dimensional view of the local air bag structure of FIG. 29. Referring to FIG. 31 and FIG. 32, specifically, the expandable degree of a bottom surface S9 of the air bag structure 612 of this embodiment is greater than the expandable degree of a top surface S10 of the air bag structure. The bottom surface S9 of the air bag structure 612 has, for example, more folds than the top surface S10 in the uninflated state shown in FIG. 31 and thus has a greater expandable degree. Accordingly, in a case where the air bag structure 612 is inflated, the expansion degree of the bottom surface S9 of the air bag structure 612 is greater than the expansion degree of the top surface S10 of the air bag structure 612, causing the air bag structure 612 to tilt up toward the central part 6121 as shown in FIG. 32, such that the air bag structure 612 as a whole becomes the configuration shown in FIG. 29 and FIG. 30.

The rest of the configurations and operation modes of the mattress 610 and the corresponding air mattress system shown in FIG. 28A to FIG. 29 are the same or similar to those of the embodiment shown in FIG. 1 to FIG. 4B, and will not be described in detail here.

In summary, in the air mattress system of the embodiments of the disclosure, the air bag structure expands and contracts along the up-down direction after being inflated or deflated so as to guide two legs of the human body on the mattress body to be lifted or lowered, and to open relatively or close relatively. Accordingly, it is possible to assist caregiving motions and prevent occupational injuries to caregivers and reduce the physical burden on patients.

What is claimed is:

1. An air mattress system, comprising:
a mattress, which comprises a mattress body, at least one air bag structure, and at least one air pressure valve, wherein the mattress body is configured to carry a human body, the at least one air bag structure is disposed on the mattress body, and the at least one air pressure valve is connected to the at least one air bag structure; and
a controller, coupled to the at least one air pressure valve, wherein the controller is configured to control the at least one air pressure valve to perform an inflation operation or a deflation operation on the at least one air bag structure,
wherein the at least one air bag structure expands along an up-down direction of the mattress body in response to the inflation operation so as to guide two legs of the human body on the mattress body to be lifted and open relatively as the at least one air bag structure expands.

2. The air mattress system according to claim 1, wherein in a head-to-tail direction of the mattress body, the at least one air bag structure is closer to a tail end of the mattress body than to a center of the mattress body.

3. The air mattress system according to claim 1, wherein the at least one air bag structure has a central part and at least one side part, and a size increase amount of the at least one side part along a size increase direction in response to the inflation operation is different from a size increase amount of the central part along the size increase direction in response to the inflation operation.

4. The air mattress system according to claim 3, wherein an expandable degree of the at least one air bag structure at the central part is greater than an expandable degree of the at least one air bag structure at the at least one side part.

5. The air mattress system according to claim 3, wherein the size increase direction is parallel to the up-down direction of the mattress body, the at least one air bag structure has at least one guide surface in response to the inflation operation, and the at least one guide surface is adapted to guide the two legs of the human body to open relatively or close relatively.

6. The air mattress system according to claim 5, wherein the at least one guide surface continuously extends between the central part and the at least one side part.

7. The air mattress system according to claim 5, wherein the size increase amount of the at least one side part along the size increase direction in response to the inflation operation is smaller than the size increase amount of the central part along the size increase direction in response to the inflation operation, such that the at least one air bag structure has the at least one guide surface extending obliquely downward from the central part to the at least one side part.

8. The air mattress system according to claim 5, wherein the at least one air bag structure has at least two air bag structures, one of the at least two air bag structures is closer to a center of the mattress body than another one of the at least two air bag structures in a left-right direction of the mattress body, the at least one guide surface of the one of the at least two air bag structures is adapted to guide the two legs of the human body on the mattress body to open relatively, and the at least one guide surface of the another one of the at least two air bag structures is adapted to guide the two legs of the human body on the mattress body to close relatively.

9. The air mattress system according to claim 8, wherein in a head-to-tail direction of the mattress body, the one of the at least two air bag structures is closer to a tail end of the mattress body than the another one of the at least two air bag structures.

10. The air mattress system according to claim 5, wherein the size increase amount of the at least one side part along the size increase direction in response to the inflation operation is greater than the size increase amount of the central part along the size increase direction in response to the inflation operation, such that the air bag structure has the at least one guide surface extending obliquely downward from the at least one side part to the central part.

11. The air mattress system according to claim 5, wherein the at least one guide surface has two guide surfaces, the at least one air bag structure has two blocks, the two blocks respectively correspond to the two guide surfaces, and when observed along the up-down direction of the mattress body, each of the blocks extends along a direction inclined to a left-right direction of the mattress body to make the at least one air bag structure V-shaped.

12. The air mattress system according to claim 3, wherein the at least one air bag structure has at least two air bag parts, the at least two air bag parts are adjacent to each other but not interconnected, and the inflation operation inflates one of the at least two air bag parts such that the size increase amount of the at least one side part along the size increase direction in response to the inflation operation is smaller than the size increase amount of the central part along the size increase direction in response to the inflation operation, or inflates another one of the at least two air bag parts such that the size increase amount of the at least one side part along the size increase direction in response to the inflation operation is greater than the size increase amount of the central part along the size increase direction in response to the inflation operation.

13. The air mattress system according to claim 12, wherein the one of the at least two air bag parts has a plurality of first sub-air bag parts, the first sub-air bag parts are sequentially stacked along the up-down direction of the mattress body, an expandable degree of one end of each of the first sub-air bag parts located at the central part is greater than an expandable degree of one end of each of the first sub-air bag parts located at the at least one side part, the another one of the at least two air bag parts has a plurality of second sub-air bag parts, the second sub-air bag parts are sequentially stacked along the up-down direction of the mattress body, and an expandable degree of one end of each of the second sub-air bag parts located at the central part is smaller than an expandable degree of one end of each of the second sub-air bag parts located at the at least one side part.

14. The air mattress system according to claim 3, wherein the size increase direction is parallel to a left-right direction of the mattress body, and the size increase amount of the at least one side part along the size increase direction in response to the inflation operation is greater than the size increase amount of the central part along the size increase direction in response to the inflation operation, such that the at least one side part is adapted to push at least one leg of the human body on the mattress body along the size increase direction in response to the inflation operation so as to guide the two legs of the human body to open relatively.

15. The air mattress system according to claim 3, wherein the at least one air bag structure has a plurality of branch parts, the branch parts are sequentially stacked along the up-down direction of the mattress body, and the branch parts are connected to each other at the at least one side part and separated from each other at the central part.

16. The air mattress system according to claim 1, wherein an expandable degree of a bottom surface of the at least one air bag structure is greater than an expandable degree of a top surface of the at least one air bag structure.

17. The air mattress system according to claim 1, further comprising: at least one auxiliary air bag and at least another air pressure valve, wherein the at least one auxiliary air bag is disposed on the mattress body, the at least another air pressure valve is connected to the at least one auxiliary air bag, the controller is coupled to the at least another air pressure valve, and the controller is configured to control the at least another air pressure valve to deflate the at least one auxiliary air bag, such that the at least one auxiliary air bag contracts along the up-down direction of the mattress body to form an accommodation space between the at least one auxiliary air bag and the human body on the mattress body.

18. The air mattress system according to claim 17, wherein in a head-to-tail direction of the mattress body, the at least one air bag structure is closer to a tail end of the mattress body than the at least one auxiliary air bag.
